(19) United States
(12) Patent Application Publication
(10) Pub. No.: US 2005/0285963 A1
(43) Pub. Date: Dec. 29, 2005

(54) Digital camera having flexible display unit

(75) Inventors: Atsushi Misawa, Saitama (JP); Hiroshi Endo, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/148,419

(22) Filed: Jun. 9, 2005

(30) Foreign Application Priority Data
Jun. 9, 2004 (JP) 2004-171654
Jun. 9, 2004 (JP) 2004-171655

(51) Int. Cl. H04N 5/222

(52) U.S. Cl. 348/333.06

(57) ABSTRACT

A digital still camera includes an image pickup device positioned on a lens optical axis. A camera body has a substantially tubular shape, contains the image pickup device, and has a peripheral surface disposed to surround the lens optical axis. A flexible display unit of an organic ELD has a sheet form, is changeable between a widely spread state and a protecting state for protection, and displays an image when widely spread. The display unit is bent on and about the peripheral surface when in the protecting state. Furthermore, a light entrance opening is formed in the camera body. A photographing optical system includes an objective optical element, namely an achromatic prism, positioned inside the light entrance opening. The display unit is opposed to a front side of the light entrance opening when in the protecting state.

### BACKGROUND OF THE INVENTION

1. Field of the Invention

The present invention relates to a digital camera having flexible display unit. More particularly, the present invention relates to a digital camera which has a flexible display unit and in which a zoom lens of a high magnification can be easily incorporated.

2. Description Related to the Prior Art

A digital camera is widely used, and includes an image sensor of CCD or CMOS type for picking up a motion picture or still image. An example of digital still camera is disclosed in JP-A 2003-078784. Recently popular types of the digital still camera have been provided with construction for zooming. For higher portability of a camera body, the digital still camera is constructed so that a lens barrel having a zoom lens is collapsed into the camera body when not used.

A display panel in the digital still camera is used to display an image for monitoring and also for playing back image data previously stored. Examples of the display panel are an organic ELD panel, liquid crystal display panel, inorganic ELD panel, or other structures of a light valve of a visible type. The organic ELD panel is characterized in use of organic EL (electroluminescence). Those examples are advantageous in having an enlarged size of frame, and a reduced thickness. Furthermore, JP-A 2003-809744 and U.S. patent Pub. No. 2003/160,892 (corresponding to JP-A 2003-250074) disclose an example of the digital still camera having a flexible and deformable type of the display panel in a sheet form. When the digital still camera is not used, the display panel is taken up and contained inside the digital still camera.

However, the digital still camera of a collapsible type known so far has a shortcoming in a limited possibility of reducing the camera size. The reduction in the size is extremely difficult specifically if a zoom lens has a high magnification to require a zoom mechanism with a great back-to-front length. In the structure disclosed in JP-A 2003-309744, the display panel in a rolled state requires a containing chamber and a take-up mechanism. It is nearly impossible to minimize the size of the entirety of the digital still camera.

### SUMMARY OF THE INVENTION

In view of the foregoing problems, an object of the present invention is to provide a digital camera which has a flexible display unit and in which a zoom lens of a high magnification can be easily incorporated.

In order to achieve the above and other objects and advantages of this invention, a digital camera includes an image pickup device positioned on a lens optical axis. A camera body has a substantially tubular shape, for containing the image pickup device, the camera body having a peripheral surface disposed to surround the lens optical axis. A display unit has a sheet form, having flexibility, being changeable between a widely spread state and a state being set about the camera body on the peripheral surface, for displaying an image when widely spread.

The camera body is connected with the display unit in a rotatable manner about an axis that extends substantially perpendicular to the lens optical axis.

The display unit protects the peripheral surface when set about.

The display unit includes a frame-shaped support having flexibility. A sheet-shaped battery and a flexible display panel are overlapped on one another, and secured to the frame-shaped support.

The display unit includes a transparent thin-film sound source, attached on the display panel, for generating sound.

The display unit has a length such that the camera body is covered partially therein. Furthermore, an exposed outer portion is included in a peripheral surface of the camera body, for exposing even when the display unit is set on and about the camera body without being covered.

Furthermore, an interface is positioned on the exposed outer portion in the camera body, for outputting image data obtained by the image pickup device to an external electronic device.

Furthermore, a power source connector is positioned on the exposed outer portion in the camera body, for being supplied with power externally.

The image pickup device includes a deflecting element for changing a direction of object light being incident, for transmitting along the lens optical axis.

The deflecting element comprises an achromatic prism including plural optical materials.

Furthermore, a light entrance opening is formed in the camera body and open to an object side. The camera body is directed to the object side with a downward inclination, and the deflecting element bends a light path of the object light with an upward inclination, and upon entering the light entrance opening, travels the object light on the lens optical axis.

In one preferred embodiment, furthermore, a light entrance opening is formed in the camera body and open to an object side. The camera body is directed to the object side with an upward inclination, and the deflecting element bends a light path of the object light with a downward inclination, and upon entering the light entrance opening, travels the object light on the lens optical axis.

In another preferred embodiment, the deflecting element comprises a single prism.

In still another preferred embodiment, the deflecting element comprises at least one mirror element.

In another preferred embodiment, the deflecting element comprises an apex angle variable prism containing liquid, and having an apex angle controllable for correcting camera shakes.

Furthermore, a rotation detector detects a rotational position of the camera body with reference to the display unit.

Furthermore, a power switch turns on or off a camera power source according to the rotational position detected by the rotation detector.

Furthermore, a rotational shaft is formed to project from one of the camera body and a connecting panel end of the display unit. A ring portion is formed on a remaining one of the camera body and the connecting panel end of the display unit, for being engaged with the rotational shaft in a rotatable manner.

Furthermore, a mode selector sets a selected one of plural camera modes according to a rotational position detected by the rotation detector.

The plural camera modes include an image pickup mode and a playback mode, the image pickup mode being adapted to photographing in the image pickup device, and the playback mode being adapted to playing back an image being stored.

The rotation detector includes a pair of switch segments for turning on by contacting one another when a first one thereof is pushed. A cam mechanism is formed on one of the rotational shaft and the ring portion, for shifting between an off position and an on position when the rotational shaft or the ring portion rotates, for coming away from the switch segments when in the off position, and for pushing the first switch segment when in the on position, to cause the switch segments to contact one another.

Furthermore, an opening is formed in the rotational shaft. A signal line is inserted through the opening and the ring portion, for signal transmission between the display unit and the camera body.

The display unit is settable in first and second rotational positions relative to the camera body, and an edge of a connecting panel end of the display unit, when in the first rotational position, extends crosswise to a longitudinal direction of the camera body, and when in the second rotational position, extends in the longitudinal direction of the camera body.

The plural camera modes include an image pickup mode and a playback mode, the image pickup mode being adapted to photographing in the image pickup device, and the playback mode being adapted to playing back an image being stored. The rotation detector checks in which of the first and second rotational positions the display unit is set. The mode selector is responsive to an output of the rotation detector, sets the image pickup mode in response to setting in the first rotational position, and sets the playback mode in response to setting in the second rotational position.

Furthermore, an input unit is disposed on the camera body, and directed in a direction in which a display surface of the display unit is directed when in the second rotational position.

In one preferred embodiment, furthermore, an input unit is disposed on the camera body, and directed in a direction in which a display surface of the display unit is directed in the playback mode.

The camera body is positioned to a right of the display unit as viewed from a user side to an object side.

The input unit is covered with the display unit set on and about the camera body.

The camera body has a substantially cylindrical shape or a shape of a polygonal prism.

Furthermore, a retaining mechanism retains the display unit on the camera body with a display surface of the display unit directed inwards in setting on and about the camera body.

The display unit is bendable in two opposite directions in a curved manner, and a display surface thereof is directed either outwards or inwards when set on and about the camera body.

In one preferred embodiment, furthermore, a retaining mechanism retains the display unit on the camera body with the display surface directed outwards.

In another preferred embodiment, furthermore, a retaining mechanism retains the display unit on the camera body with the display surface directed inwards, and retains the display unit on the camera body with the display surface directed outwards.

In still another preferred embodiment, furthermore, a retaining mechanism retains the display unit on the camera body with the display surface directed inwards. An auxiliary retaining mechanism retains the display unit on the camera body with the display surface directed outwards.

Furthermore, a standby image switch causes the display unit to display a standby image on a display surface thereof while the display unit is set on and about the camera body with the display surface directed outwards.

Furthermore, a power source switch turns off a camera power source when the display unit is set on and about the camera body, and turns on the camera power source when the display unit is spread from the camera body, to supply power.

Furthermore, a retaining mechanism is formed on the camera body, for squeezing an edge of the display unit.

The display unit includes a frame-shaped support having flexibility. A flexible display panel is secured to the frame-shaped support. Protection film protects a rear of the display panel and the frame-shaped support.

Furthermore, a light transmitting pattern is formed in one portion of the protection film, and has a shape for representing information.

Furthermore, a resilient element has an extending characteristic, for developing the display unit flatly upon disengagement of a free end of the display unit from the camera body.

The display unit includes a display panel for displaying an image. The resilient element is incorporated in the display panel.

The resilient element has a wire shape or flat plate shape.

In another preferred embodiment, furthermore, a plastically deformable element has a plastically deformable characteristic, being overlapped on the display unit, for keeping the display unit rolled upon setting on and about the camera body, and for setting the display unit flat upon spreading from the camera body.

In another aspect of the invention, a digital camera includes an image pickup device positioned on a lens optical axis. A camera body has a substantially tubular shape, for containing the image pickup device, the camera body having a peripheral surface disposed to surround the lens optical axis. A display unit has a sheet form, has flexibility, being changeable between a widely spread state and a protecting state to protect the peripheral surface on the camera body, for displaying an image when widely spread.

The display unit is bent on and about the peripheral surface when in the protecting state.

The display unit includes a first end connected with the camera body.

Furthermore, a light entrance opening is formed in the camera body and open to an object side. A photographing optical system includes at least one objective optical element positioned inside the light entrance opening. The display unit is opposed to a front side of the light entrance opening when in the protecting state.

Furthermore, an input unit is positioned on the camera body, for being covered by the display unit in the protecting state.

The display unit is connected with the camera body in a rotatable manner about an axis that extends substantially perpendicular to the lens optical axis.

In one aspect of the invention, a digital camera having a photographing lens includes a camera body in which the photographing lens is incorporated. An image pickup device is incorporated behind the photographing lens in the camera body, for photographing an object image. A display unit has a sheet form, has flexibility, has a first end connected with the camera body, for being set on and about a periphery of the camera body, and for displaying an image when widely spread according to an image pickup signal from the image pickup device.

Furthermore, a resilient element has an extending characteristic, for developing the display unit flatly upon disengagement of a second end from the camera body, the second end being opposite to the first end.

In still another preferred embodiment, furthermore, a plastically deformable element has a plastically deformable characteristic, being overlapped on the display unit, for keeping the display unit rolled in a state set on and about the camera body, and for setting the display unit flat in a state spread from the camera body.

The plastically deformable element is metal, and extends along one edge of the display unit.

The display unit has a length such that the camera body is covered partially therein. Furthermore, an exposed outer portion is included in a peripheral surface of the camera body, for exposing even when the display unit is set on and about the camera body without being covered.

Furthermore, an interface is positioned on the exposed outer portion in the camera body, for outputting image data obtained by the image pickup device to an external electronic device.

Furthermore, a power source controller is responsive to connection with the electronic device by the interface, for turning on the camera power source.

The camera body is in a substantially tubular shape with a peripheral surface provided with at least one of the photographing lens, a flash light source and a camera input unit, and the display unit protects the peripheral surface when set about.

Furthermore, a hinge mechanism secures the camera body in a rotatable manner to the display unit at the first end.

Furthermore, a shiftable power switch is set in an off position when the display unit is set on and about the camera body, and set in an on position when the display unit is spread from the camera body. A power source controller detects shifting of the power switch, turns off a camera power source when the power switch is in the off position, and turns on the camera power source when the power switch is in the on position, to supply power.

In another preferred embodiment, furthermore, an additional switch is shiftable according to a selected one of a rolled position where the display unit is set on and about the camera body, and a spread position where the display unit is spread from the camera body. A mode selector detects shifting of the additional switch, and changes over a camera mode to a standby mode when the display unit is in the rolled position, and changes over the camera mode to an image pickup mode or playback mode when the display unit is in the spread position, wherein the standby mode is adapted to displaying a standby image on the display surface, the image pickup mode is adapted to photographing in the image pickup device, and the playback mode is adapted to playing back an image being stored.

In one preferred embodiment, furthermore, a power switch outputs an inward direction signal when the display unit is set on and about the camera body by directing a display surface thereof is directed inwards. An additional switch outputs an outward direction signal when the display unit is set on and about the camera body by directing the display surface is directed outwards. A power source controller turns off a camera power source responsively when the inward direction signal is output, and turns on the camera power source before outputting of the inward direction signal, or after completion of outputting of the inward direction signal. A mode selector changes over a camera mode to a standby mode responsively when the outward direction signal is output, and changes over the camera mode to an image pickup mode or playback mode before outputting of the outward direction signal, or after completion of outputting of the outward direction signal, wherein the standby mode is adapted to displaying a standby image on the display surface, the image pickup mode is adapted to photographing in the image pickup device, and the playback mode is adapted to playing back an image being stored.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a digital still camera;

FIG. 2 is a perspective view illustrating a rotated state of the camera;

FIG. 3 is an explanatory view in vertical section illustrating an optical structure of the camera;

FIG. 4 is an exploded perspective illustrating a display unit;

FIG. 5 is a perspective view illustrating a rolled state of the camera;

FIG. 6 is an exploded perspective illustrating a hinge mechanism;

FIG. 7 is a block diagram schematically illustrating circuit elements of the camera;

FIG. 8 is a perspective view illustrating a state of the camera in an image pickup mode;

FIG. 9 is a perspective view illustrating a state of the camera in a playback mode;

FIG. 10A is a side elevation illustrating one preferred camera in a rolled state;

FIG. 10B is a perspective view illustrating the rolled state of the camera;

FIG. 11A is an explanatory view in side elevation illustrating one preferred image pickup optical system including a single prism;

FIG. 11B is an explanatory view in side elevation illustrating one preferred image pickup optical system;

FIG. 12 is an explanatory view in side elevation illustrating one preferred image pickup optical system with a liquid prism;

FIG. 13 is a perspective view illustrating one preferred digital still camera;

FIG. 14 is a perspective view illustrating disposition of a standby image switch;

FIG. 15 is a perspective view illustrating a rolled state with the display surface directed outwards;

FIG. 16 is a perspective view illustrating a retrained state of the display unit;

FIG. 17 is a perspective view illustrating one preferred digital still camera manually holdable in a particular orientation;

FIG. 18 is an exploded perspective illustrating one preferred display unit including a logo indicia;

FIG. 19 is an exploded perspective illustrating a display unit of a simplified embodiment;

FIG. 20 is an exploded perspective illustrating one preferred display unit provided with a stainless flat panel;

FIG. 21 is a perspective view illustrating one preferred digital still camera;

FIG. 22 is a perspective view illustrating a rear of the camera;

FIG. 23 is an exploded perspective illustrating a display unit;

FIG. 24 is a perspective view illustrating a rolled state of the camera;

FIG. 25 is a perspective view illustrating one preferred digital still camera in a widely spread state;

FIG. 26 is a perspective view illustrating in a rolled state;

FIG. 27 is a perspective view illustrating one preferred digital still camera including a shape memory alloy wire;

FIG. 28 is a perspective view illustrating one preferred digital still camera:

FIG. 29 is an exploded perspective illustrating one preferred display unit including protection film;

FIG. 30 is an exploded perspective illustrating a simplified display unit;

FIG. 31 is a perspective view illustrating a connected state of the camera to a computer;

FIG. 32 is a perspective view illustrating one preferred digital still camera in which a display unit is squeezed for retention;

FIG. 33 is a perspective view illustrating one preferred digital still camera;

FIG. 34 is a perspective view illustrating one preferred digital still camera including wire and in a widely spread state;

FIG. 35 is a perspective view illustrating a rolled state of the digital still camera;

FIG. 36 is a perspective view illustrating one preferred digital still camera of a reversible structure and in a widely spread state;

FIG. 37 is a perspective view illustrating one preferred digital still camera;

FIG. 38 is a perspective view illustrating a rolled state of the camera;

FIG. 39 is an exploded perspective illustrating one preferred display unit including a sheet speaker;

FIG. 40 is a block diagram schematically illustrating circuit elements of the camera of each of FIGS. 31-38;

FIGS. 40A and 40B are perspective views illustrating other preferred cameras having a prismatic shaped body.

### DETAILED DESCRIPTION OF THE PREFERRED EMBODIMENT(S) OF THE PRESENT INVENTION

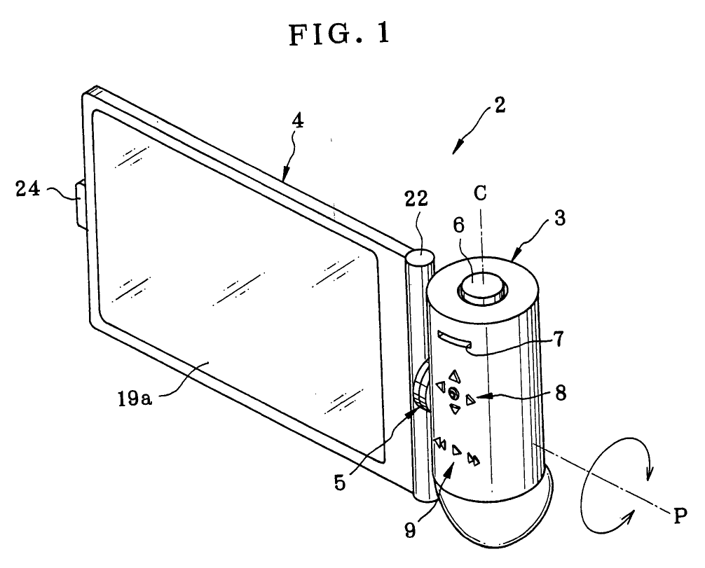

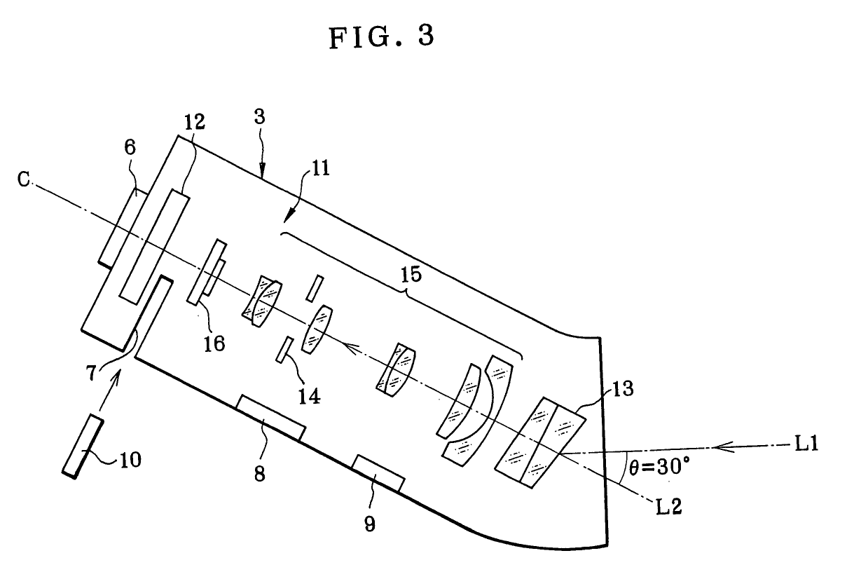

In FIG. 1, a front of a digital still camera 2 of the invention is illustrated. The digital still camera 2 includes a camera body 3, a display unit 4, and a rotational supporting mechanism 5. The camera body 3 has a cylindrical shape, in which an imaging unit 11 is incorporated. See FIG. 3. The display unit 4 has a shape of a thin sheet. The rotational supporting mechanism 5 connects the camera body 3 to the display unit 4 in a rotatable manner.

A shutter release button 6 is disposed on an upper face of the camera body 3. A front face of the camera body 3 is provided with a memory card slot 7, an input panel 8 and a playback operation panel 9. See FIG. 3. A memory card 10 is inserted into the memory card slot 7, and stores image data obtained by pickup. The input panel 8 includes a direction key, and is operable for zooming and determining various settings. The playback operation panel 9 is a reproduction operation panel used in an image playback mode and operable for starting and stopping the playback, changing over frames in a forward or backward direction, and the like.

The shutter release button 6 or a shutter switch is a two-step depressible type. When the shutter release button 6 is depressed halfway for a first step, then the circuits in the camera operate for auto-exposure (AE) and auto-focusing (AF) for the purpose of standby for image pickup. When the shutter release button 6 is depressed fully for a second step, an image is picked up.

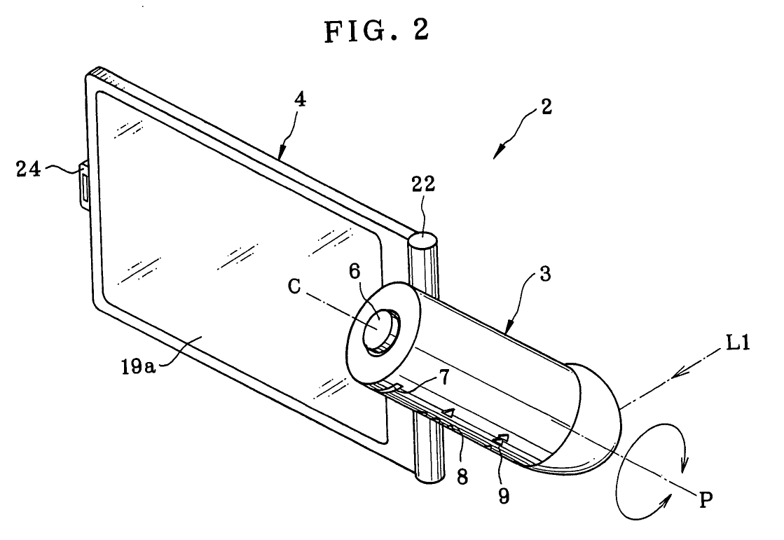

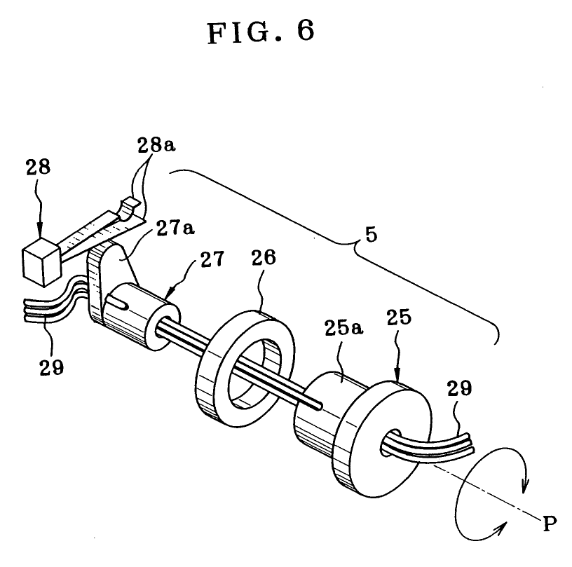

The camera body 3 is rotatable forwards and backwards about the rotational axis P with respect to the display unit 4 with the rotational symmetrical axis C kept vertical with the rotational axis P, the rotational symmetrical axis C extending up or down through the cylindrical shape. In FIG. 2, the digital still camera 2 is set in an effective state when the camera body 3 is rotated to direct the upper end to a user side or rear side. Object light traveling along the entrance light axis L1 becomes incident upon the camera body 3. As will be described, the entrance light axis L1 extends with an inclination to a rotational symmetrical axis C of the cylindrical shape. A lower end of the camera body 3 for entry of object light is bent in a direction of the entrance light axis L1. A rotation detecting switch 28 or power switch is depicted in FIG. 6, contained in the rotational supporting mechanism 5, and operates for changing over the digital still camera 2 in response to rotation of the camera body 3.

In FIG. 3, the camera body 3 contains the imaging unit 11 which has a zooming structure. An image recording circuit board 12 is contained in the camera body 3 and includes various circuits. The circuit board 12 is responsive to signals output by the switch of the shutter release button 6, the input panel 8 and the playback operation panel 9, and controls various elements which are the imaging unit 11, the memory card 10 loaded in the card slot, and the display unit 4, and also processes image data obtained by the imaging unit 11.

The imaging unit 11 includes an achromatic prism 13, a zoom lens 15, and an image sensor or solid state image pickup device 16. An aperture stop mechanism 14 is disposed between plural lens elements in the zoom lens 15. The achromatic prism 13 is a deflecting element constituted by two prisms of high-dispersion glass and low-dispersion glass, for eliminating color dispersion. The achromatic prism 13 changes a direction of the object light having entered on the optical axis L1, and directs the object light on a lens optical axis L2 which extends at an angle θ with respect to the optical axis L1. An angle θ is an angle of bending a path of the object light with the achromatic prism 13. A preferred example of the angle θ is 30 degrees. However, it is possible to determine the angle θbetween 10 degrees and 45 degrees.

The zoom lens 15 is kept movable in the optical axial direction L2 by a guiding mechanism (not shown). A lens motor (not shown) drives the zoom lens 15 for zooming and focusing. The zoom lens 15 has a prescribed zoom magnification, for example 10 times. The image sensor 16 is disposed on the optical axis L2, and converts object light focused by the zoom lens 15 photoelectrically into an image signal. An example of the image sensor 16 is a CCD (charge coupled device) image sensor or CMOS image sensor.

The imaging unit 11 is so disposed to set the line L2 along the rotational symmetrical axis C extending on the center of the cylindrical shape. This makes it possible to use an inner space of the camera body 3 with considerable efficiency. An outer contour of the camera body 3 is cylindrical itself in a manner of a lens barrel. Thus, the imaging unit 11 can be accommodated in the camera body 3 with ease internally with a zoom mechanism of a high zoom magnification.

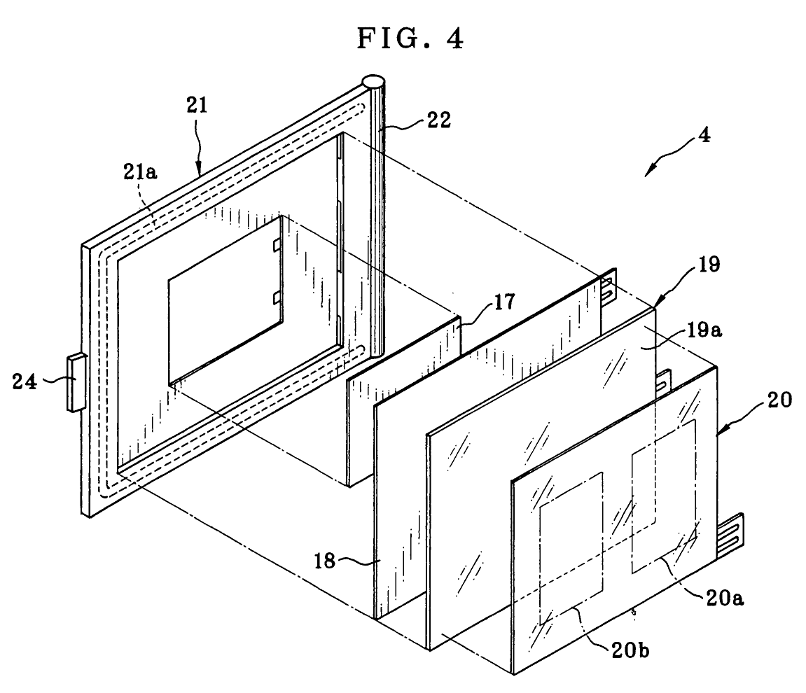

In FIG. 4, the display unit 4 is constituted by a sheet battery or sheet-shaped battery 17, a flexible wiring board 18, an organic ELD (electroluminescence display) panel 19, and a bezel 21 as frame-shaped support for supporting those elements. A stereo type of sheet speaker or sound source 20 of transparent film is attached to a display surface 19a of the organic ELD panel 19. The sheet battery 17 is a secondary battery having a small thickness, and consists of polymer of electrolyte, and lithium alloy and carbon oxide between which the polymer of electrolyte is sandwiched. The sheet battery 17 is highly flexible, and can be deformed at a high degree of freedom.

The organic ELD panel 19 is a flexible display panel, and includes a transparent plastic base plate, two electrode layers of an anode and cathode, and numerous organic EL elements. The base plate has flexibility. The two electrode layers of an anode and cathode are overlaid on the base plate. The organic EL elements are mounted between the two layers, and consist of organic molecules that are either monomer, oligomer or polymer. When voltage is applied across the two electrode layers constituting the anode and cathode, the organic EL element is caused to emit light. One pixel is constituted by each of the plural organic EL elements. An image is displayed by selective illumination of the organic EL elements arranged in a matrix form.

The sheet speaker 20 consists of macromolecular piezoelectric film and electrically conductive polymer, is highly flexible, and can be deformed at a high degree of freedom. An R channel speaker unit or sound source unit 20a generates sounds of an R channel. An L channel speaker unit or sound source unit 20b generates sounds of an L channel. The sheet speaker 20 is attached to the display surface 19a of the organic ELD panel 19, but has sufficient transmittance for keeping an image on the display surface 19a visible with high clarity.

The flexible wiring board 18 is connected electrically with terminal points of the sheet battery 17, the organic ELD panel 19 and the sheet speaker 20. The sheet battery 17, the flexible wiring board 18, the organic ELD panel 19 and the sheet speaker 20 are overlaid on one another in sequence, and then are secured to the bezel 21.

The bezel 21 has a generally quadrilateral shape. A panel end 22 for connection of the bezel 21 has a rod shape, and connectable with the camera body 3 by means of the rotational supporting mechanism 5. A shape memory alloy wire 21a is incorporated in each of upper, vertical and lower edge portions of the bezel 21 as frame-shaped support, and maintains flatness of the display unit 4. The bezel 21, upon receipt of external force, is deformed resiliently, and when the external force discontinues at the bezel 21, is spread flatly by the shape memory alloy wire 21a. A retention projection 24 protrudes from a left edge of the bezel 21. A retention slot 24a is formed in the retention projection 24.

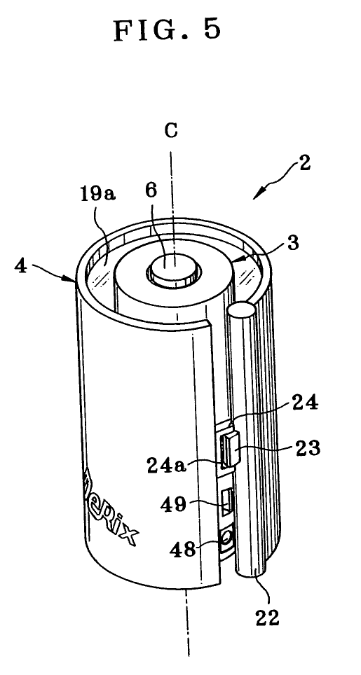

The display unit 4 has flexibility, and can be bent in a roll form about an axis along the panel end 22. A retention claw or hook 23 is formed with the panel end 22, and engageable with the retention slot 24a of the retention projection 24 when the display unit 4 is kept in the roll form as illustrated in FIG. 5. In FIG. 5, a rolled state of the digital still camera 2 for portability is depicted.

The display unit 4 is wound on the camera body 3 about the axis C or optical axis L2 with the display surface 19a positioned inside. At this time, the input panel 8 and the playback operation panel 9 are covered with the display unit 4, and can be prevented from being operated erroneously. Note that the retention claw 23 may be formed with the camera body 3 or the rotational supporting mechanism 5 in place of the panel end 22.

A DC jack 48 and a USB (Universal Serial Bus) port 49 of an interface are disposed on the camera body 3 near to the panel end 22. The DC jack 48 is a power source connector for being supplied with power by an electric outlet, or for connection with a plug to charge the sheet battery 17 electrically. The USB port 49 constitutes an interface of communication for outputting image data to a personal computer or other electronic devices. The DC jack 48 and the USB port 49 constantly appear externally because positioned offset from the display unit 4 fitted about the camera body 3. Supply of power and communication of data are possible even while the display unit 4 is rolled and not used.

In FIG. 6, the rotational supporting mechanism 5 includes a camera rotational shaft 25, a ring portion 26 and a rotation detecting cam mechanism 27 as well as the rotation detecting switch 28. The rotational shaft 25 is 30 firmly fixed on the camera body 3. The ring portion 26 is secured to the display unit 4. A bush portion 25a having an opening receives the ring portion 26 in a slidable manner. The rotation detecting cam mechanism 27 is connected with the bush portion 25a of the rotational shaft 25 together with the ring portion 26, and rotates in response to rotation of the camera body 3. Two switch segments 28a constitute the rotation detecting switch 28. A cam projection 27a protrudes from the rotation detecting cam mechanism 27, and presses the rotation detecting switch 28 to cause the switch segments 28a to contact one another. The rotation detecting switch 28 is turned on and off by rotation of the camera body 3 about the rotational axis P of the rotational supporting mechanism 5.

In the present embodiment, the rotation detecting switch 28 is positioned on the side of the display unit 4. However, it is possible to dispose the rotation detecting switch 28 inside the camera body 3 in contrast with the structure depicted in the drawing.

Through holes are formed at centers of the rotational shaft 25 and the rotation detecting cam mechanism 27. A signal line 29 connects the display unit 4 electrically with the camera body 3, and is inserted through the rotational shaft 25, the ring portion 26 and the rotation detecting cam mechanism 27 in a sequence. The signal line 29 is positioned so suitably that it does not obstruct rotation of the rotational supporting mechanism 5.

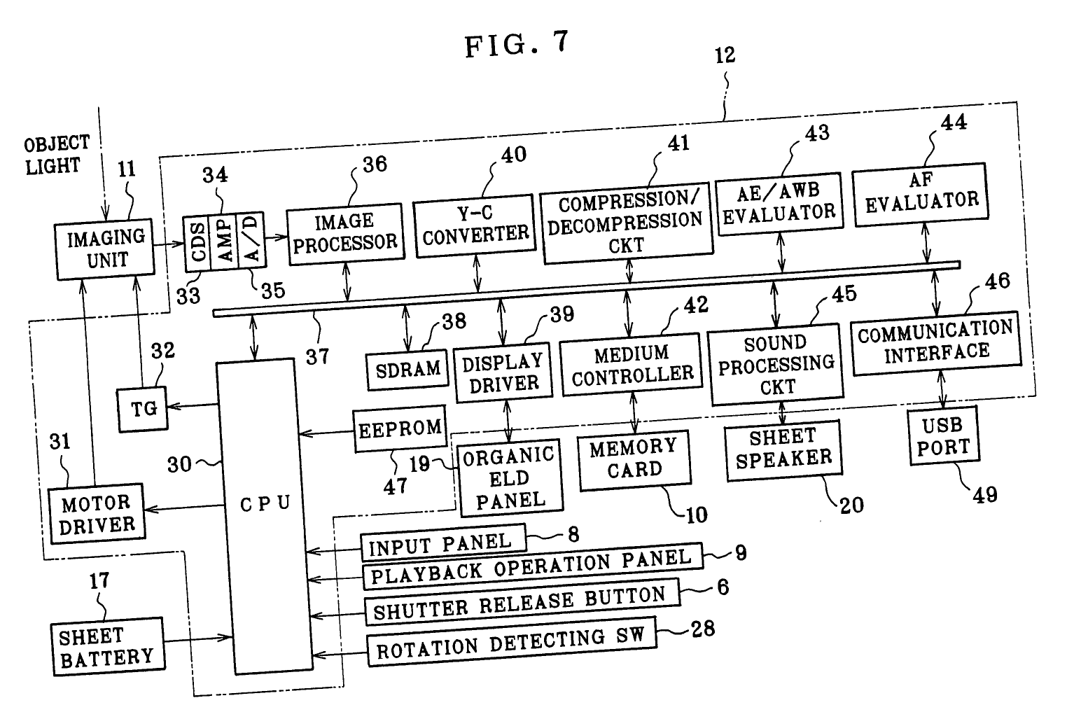

In FIG. 7, circuitry in the digital still camera 2 is illustrated. A lens motor (not shown) is incorporated in the imaging unit 11, for driving the zoom lens 15. An iris motor (not shown) in the imaging unit 11 drives the aperture stop mechanism. Each of the lens motor and the iris motor is a stepping motor. A motor driver 31 is connected with those motors. A CPU 30 causes the motor driver 31 to send drive pulses to the motors, to stand by the camera for an exposure in response to half depression of the shutter release button 6.

The lens motor causes the zoom lens 15 to move in one of directions toward the wide-angle end and telephoto end in response to the operation of the input panel 8. Also, the lens motor moves a focusing lens or variator lens (not shown) according to zooming of the zoom lens 15 or an object distance, and adjusts the focal point to optimize the condition of exposure. The iris motor moves the aperture stop mechanism 14, to adjust an amount of exposure.

The image sensor 16 in the imaging unit 11 functions as an electronic shutter. A timing generator (TG) 32 is connected with the image sensor 16, and controlled by the CPU 30, for generating a timing signal or clock pulse. A shutter speed of the electronic shutter is determined by inputting of the timing signal to the image sensor 16.

A correlated double sampling circuit (CDS) 33 is supplied with an image pickup signal output by the image sensor 16, and generates image data of the red, green and blue colors according to amounts of stored charge of cells in the image sensor 16. An amplifier 34 amplifies image data output by the correlated double sampling circuit 33. An A/D converter 35 converts the amplified image data to digital image data.

An image processor 36 is supplied with the image data from the A/D converter 35, and subjects the same to image processing, for example gradation correction, white balance (WB) correction, gamma-correction and the like. A data bus 37 is connected with the image processor 36. An SDRAM 38 is connected with the data bus 37, through which the image data from the image processor 36 is stored in the SDRAM 38 in a temporary manner. A display driver 39 or display controller causes the organic ELD panel 19 to display a live image according to the image data.

A Y-C converter 40 reads image data from the SDRAM 38 in a processed form of image processing of various types by means of the image processor 36, and converts the processed image data into a brightness signal Y and color difference signals Cr and Cb. A compression/decompression circuit 41 compresses the converted image data according to a prescribed compressing format, for example JPEG (Joint Picture Expert Group) format. A medium controller 42 is supplied with a data file obtained by the compression, and writes the same to the memory card 10 set in the memory card slot 7.

There is an AE/AWB evaluator 43 for checking whether an exposure amount defined by the shutter speed and aperture stop value is suitably set for photographing, and for checking whether a white balance condition is suitable for photographing. An AF evaluator 44 checks whether focusing of the imaging unit 11 is adjusted suitably for photographing. A sound processing circuit 45 plays back sound data stored in the memory card 10, and causes the sheet speaker 20 to generate sounds or voices audibly. A communication interface 46 is adapted to communication at the USB port 49.

The AE/AWB evaluator 43 and the AF evaluator 44 are responsive to the half depression of the shutter release button 6, and sends results of the detection successively to the CPU 30 through the data bus 37. The CPU 30 is according to the detection results of the AE/AWB evaluator 43 and the AF evaluator 44, and controls the motor driver 31 and the timing generator 32 to adjust an exposure amount of the imaging unit 11.

An EEPROM 47 is connected with the CPU 30 as well as the sheet battery 17, the rotation detecting switch 28 and other input elements. The EEPROM 47 stores a control program and various setting information. The CPU 30 reads the information from the EEPROM 47, writes the same to the SDRAM 38 as a work memory, and executes routines of various items.

The sheet battery 17 supplies various elements with power through the CPU 30. The switches of the input panel 8 and the playback operation panel 9 generate an electric signal according to operation of command by the user, and sends the signals to the CPU 30. The switch of the shutter release button 6 generates an electric signal according to the half depression or full depression of the shutter release button 6 by the user, and sends the signal to the CPU 30. The rotation detecting switch 28 sends the CPU 30 a signal of being on or off according to a rotational position of the camera body 3 relative to the display unit 4. The CPU 30 controls the relevant circuits according to the on or off signal, and changes over the digital still camera 2 by setting the playback mode or image pickup mode. Note that it is possible to turn on or off the power supply in response to the on and off signals of the rotation detecting switch 28.

In the image pickup mode, a still image or motion picture is photographed, of which data is written to the memory card 10. In the playback mode, the still image data or motion picture data stored in the memory card 10 is read and played back on the organic ELD panel 19. Note that a microphone (not shown) may be incorporated in the camera, and used for recording sound while the motion picture is picked up. Data of the recorded sound can be written to the memory card 10 together with the motion picture data.

In the drawing, the elements indicated by the phantom lines are disposed on the circuit board 12 in the digital still camera 2. However, it is possible to modify the circuits on the circuit board 12 in various manners.

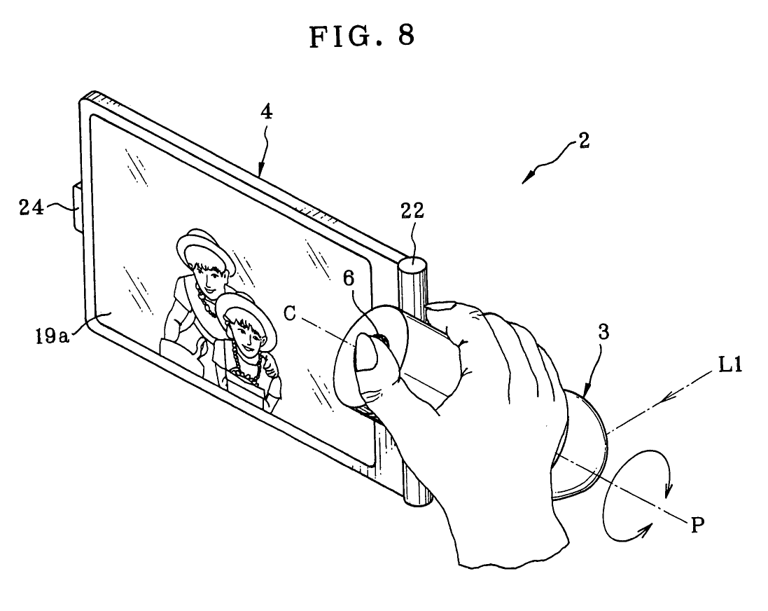

The operation of the digital still camera 2 is described now. To photograph an image with the digital still camera 2, a user disengages the retention claw 23 from the retention projection 24 as illustrated in FIG. 8, and spreads and flattens the display unit 4. The camera body 3 is rotated about the rotational axis P, to set the optical axis L1 in a photographing direction toward an object.

A right hand of the user can easily grasp the camera body 3 as a grip portion in a cylindrical shape. His or her thumb can depress the shutter release button 6 very readily. Also, the lower end of the camera body 3 is bent to direct the optical axis L1 with an inclination to the rotational symmetrical axis C of the camera body 3 for entry of the object light. A wrist of the hand of the user can be free from excessive load in easily handling the camera body 3. The rotation detecting switch 28 is turned off. The digital still camera 2 is in the image pickup mode.

When the user operates the input panel 8 to select one of the still image photographing mode and motion picture photographing mode, object light being incident is converted into digital image data for each of the two modes. A live image is displayed on the organic ELD panel 19 driven according to the digital image data. The user targets and frames an object in holding the camera body 3, and moves his or her thumb to depress the shutter release button 6.

In the still image pickup mode, when the shutter release button 6 is depressed halfway, standby operation is made for an exposure. When the shutter release button 6 is fully depressed, image data of one frame stored in the SDRAM 38 is compressed, and written to the memory card 10.

The motion picture pickup mode is described. When the shutter release button 6 is depressed fully, the motion picture pickup is started. Image data are written to the memory card 10 at a constant frame rate, for example 30 frames per second until the shutter release button 6 is fully depressed again. If the camera has a microphone, voices and other ambient sounds are recorded during the motion picture pickup, and written to the memory card 10 in association with the image data.

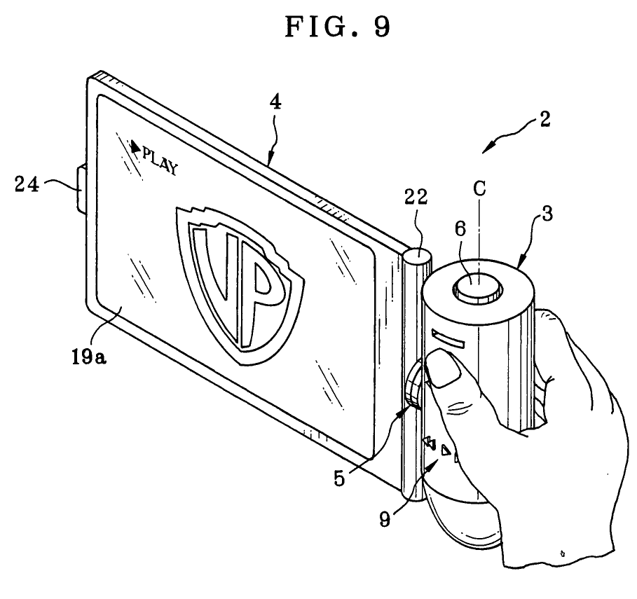

After the image is picked up, the camera body 3 is rotated as illustrated in FIG. 9, to shift back the camera body 3 to a state parallel to a direction of the panel end 22 of the display unit 4. The display surface 19a of the display unit 4 is directed toward the user side as well as the input panel 8 and the playback operation panel 9. At this time, the rotation detecting switch 28 is turned on. The digital still camera 2 is in the playback mode. The user suitably pushes the input panel 8 and the playback operation panel 9 with his or her right hand, to play back image data or sound data read from the memory card 10, to enjoy viewing and hearing those. Also, data of a great size for a movie film can be previously stored in the memory card 10, and can be played back for browsing.

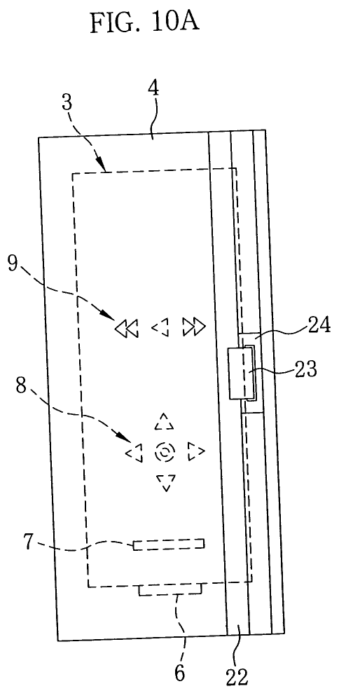

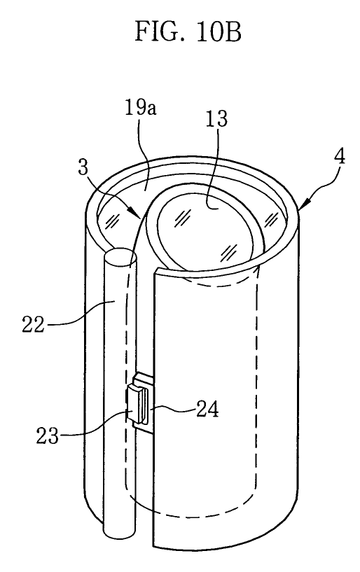

In FIGS. 10A and 10B, an example of the digital still camera 2 having the display unit 4 in a widened shape is illustrated. When the display unit 4 is set on and about the camera body 3, various elements are covered and protected from external operation, including the shutter release button 6, the memory card slot 7, the input panel 8 and the playback operation panel 9, and also the flash light source and window of a viewfinder. Also, the achromatic prism 13 for the photographing lens at the end of the camera body 3 is located within a contour of the display unit 4. This is effective in protection so as to prevent erroneous manual handling of the camera.

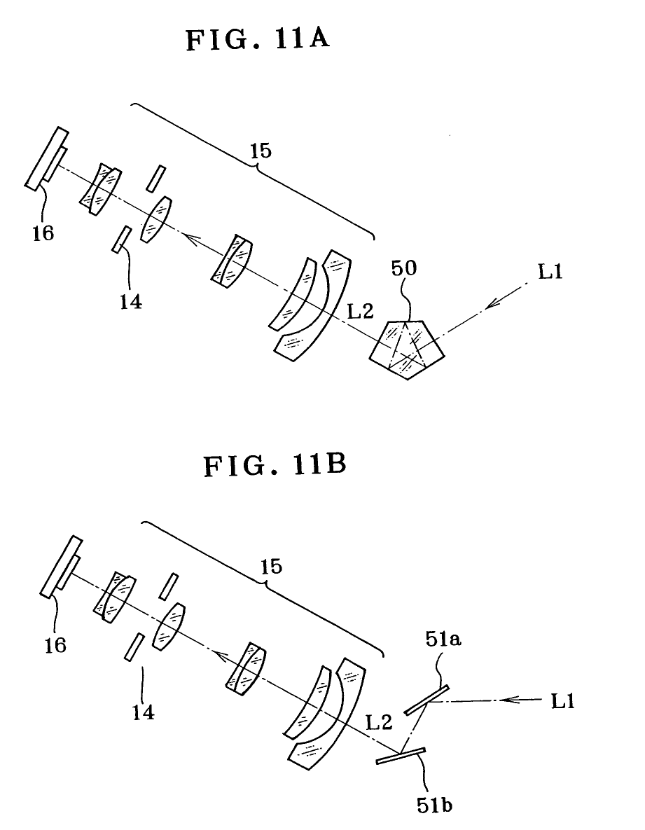

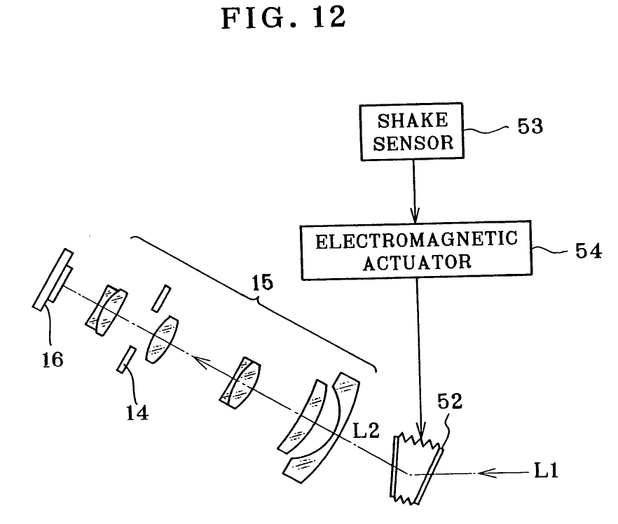

In FIG. 11B, an example different from the above embodiment is illustrated, in which a single prism 50 is used as a deflector for bending a light path. In FIG. 11B, another example with at least one mirror is illustrated, in which two mirror elements 51a and 51b are used for reflection. In FIG. 12, an example is illustrated, in which a liquid prism or apex angle variable prism 52 is used.

The apex angle variable prism 52 consists of two glass panels, bellows for connecting those, and liquid of a high refraction index filled therein. An apex angle of the apex angle variable prism 52 is changeable by deforming the bellows. Such a change in the apex angle causes the deflecting direction to change. Also, a shake sensor 53 detects camera shakes or manual shakes of a user holding the camera body 3. An electromagnetic actuator 54 is energized according to the detection signal of the shake sensor 53. The apex angle of the apex angle variable prism 52 is controlled, so manual shakes can be prevented from influencing image quality because the optical axis L1 can be held immovably. This structure of the apex angle variable prism 52 is disclosed in JP-A 11-052445, and U.S. Pat. No. 5,481,394 (corresponding to JP-A 6-082888).

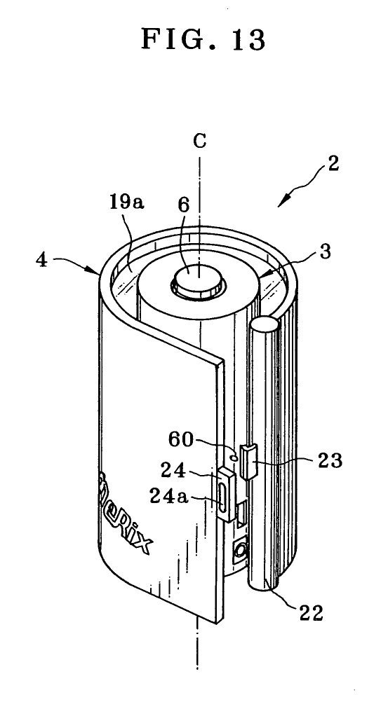

In FIG. 13, an example of the camera body 3 has a power switch 60 disposed close to the retention claw 23. The power switch 60, when depressed, turns off powering with the sheet battery 17, and when released from depression, turns on the powering of the sheet battery 17. When the digital still camera 2 is not used, the retention projection 24 of the bezel 21 depresses the power switch 60 to turn off the power supply. When the retention claw 23 is disengaged from the retention slot 24a for an effective state, the power switch 60 is released from depression to turn on the power supply. This structure is advantageous in removing operation from a user for turning on and off the power supply of the digital still camera 2. The digital still camera 2 can be set up in the effective state when the user wishes to use the digital still camera 2. The power switch 60 is a normal open switch in a pushbutton form.

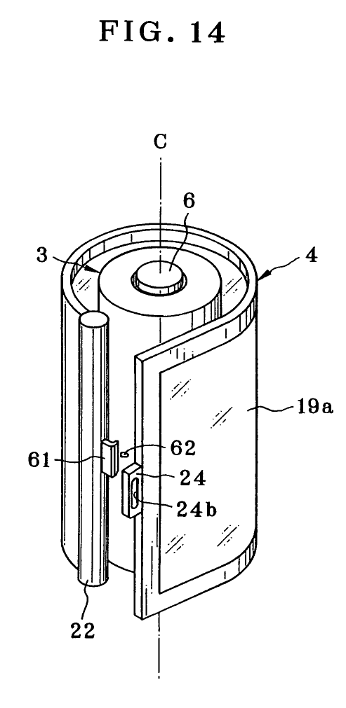

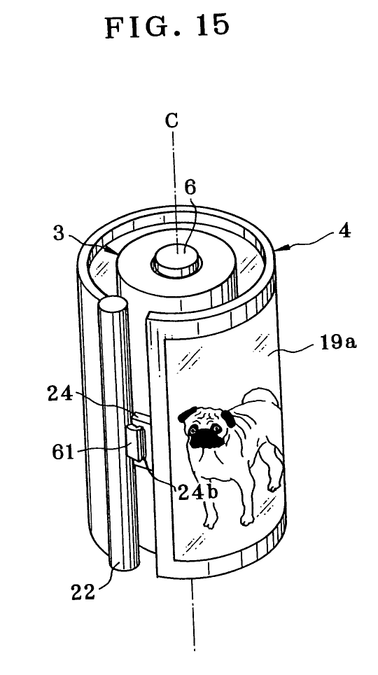

Unlike the above embodiment, the display unit 4 can be fitted about the camera body 3 by directing the display surface 19a externally according to the invention. See FIG. 14. A retention claw or hook 61 is formed with the panel end 22. A retention slot 24b is formed in the retention projection 24 for retaining the retention claw 61. In FIG. 15, the display unit 4 is set on the outside of the camera body 3 with the display surface 19a directed outside. This makes it possible to determine a selected one of the inward and outward directions in which the display surface 19a is set and directed. Note that a suitable image, either still image or motion picture, can be displayed in the display surface 19a directed externally even while the display unit 4 is rolled and not used for observation. This is effective in imparting a new idea to appearance of the digital still camera 2.

In FIG. 14, a structure with a standby image switch 62 is illustrated. The standby image switch 62 is an additional switch with a form of a pushbutton disposed near to the retention claw 61 of the camera body 3, and depressed to cause the display surface 19a to display a standby image. When the display unit 4 in the digital still camera 2 is rolled to set the display surface 19a externally, the standby image switch 62 is depressed by the retention projection 24 of the bezel 21. The standby image is caused automatically to appear on the display surface 19a.

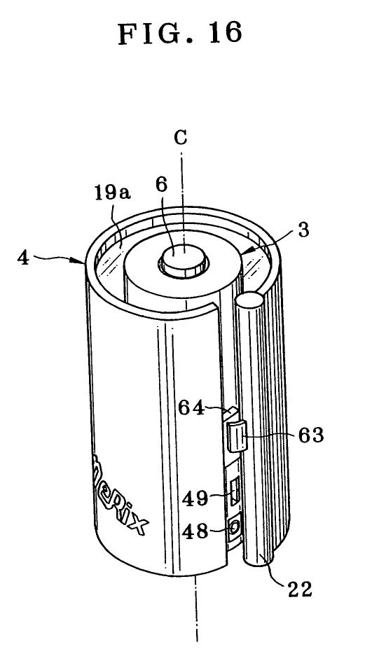

In FIG. 16, an example of differently retaining an end of the display unit 4 on the camera body 3 is illustrated. Unlike the structure including the retention claw 23 and the retention projection 24, a fastening clamp 63 is formed with the panel end 22. A fastening end projection 64 protrudes from an end of the display unit 4, and is squeezed between the camera body 3 and the fastening clamp 63 for retention of the display unit 4. Note that the fastening clamp 63 can be formed with the camera body 3.

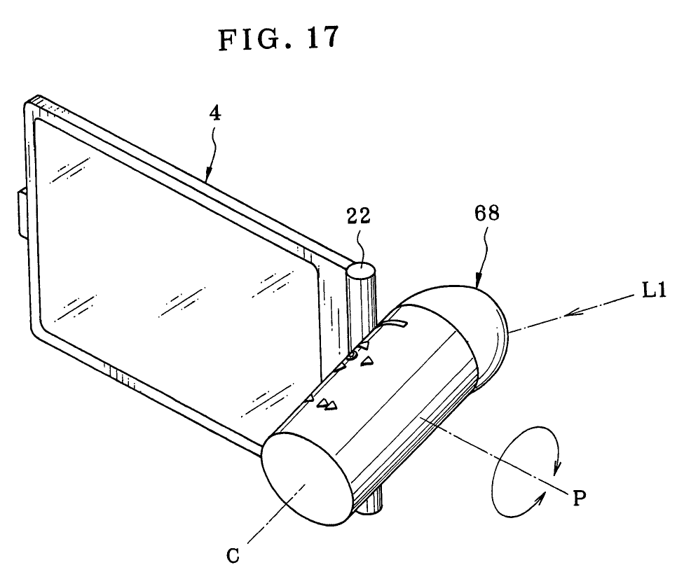

In FIG. 17, a camera body 68 of another preferred embodiment is illustrated. Unlike the above embodiment, a front of the camera body 68 is directly upwards with an inclination. Object light becomes incident on the optical system in the camera body 68 in a direction downwards through an upper end of the camera body 68. The front end of the camera body 68 has a bent shape, which extends along a bent shape of the optical axis L1. It is to be noted that the camera body 68 may have an entirely cylindrical shape without a bent portion.

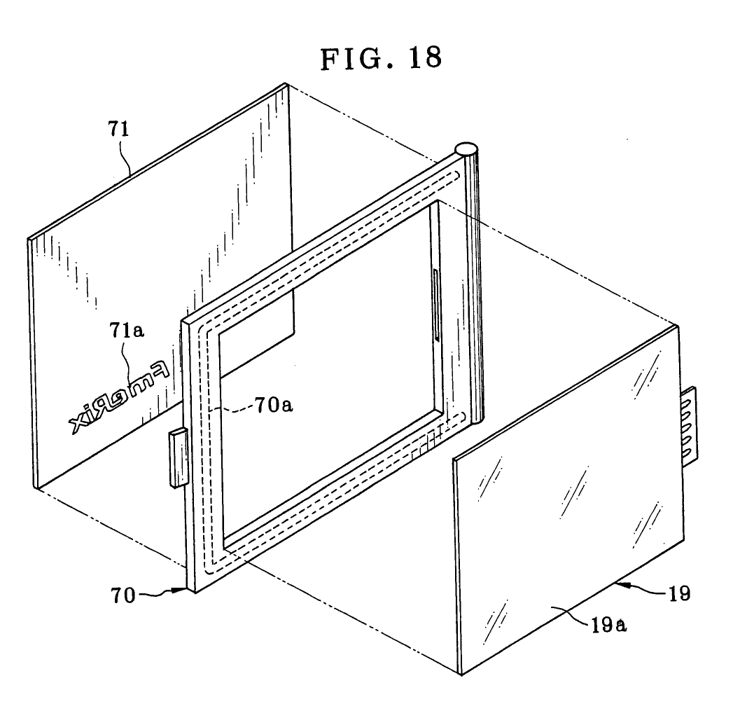

Further modifications of the display unit 4 are possible. In FIGS. 18-20, other examples of display units are illustrated.

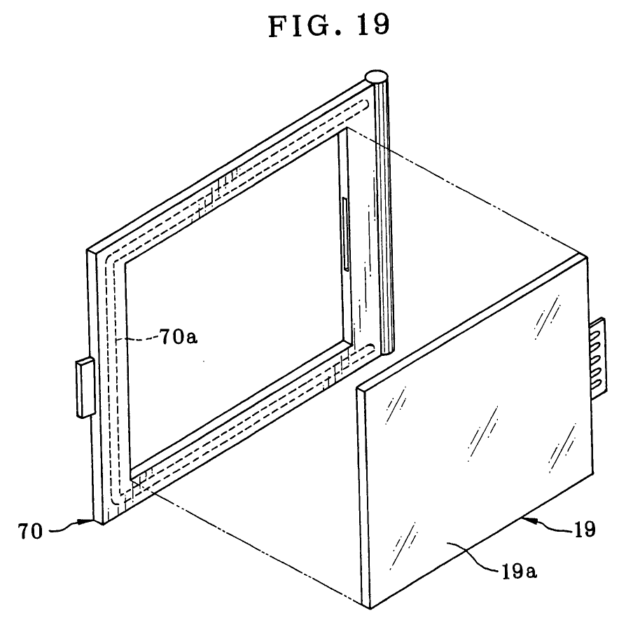

In FIG. 18, the display unit 4 is illustrated. A bezel 70 supports the organic ELD panel 19. A flexible protection film 71 covers the rear of the organic ELD panel 19 and the bezel 70. Note that the sheet battery 17 of the above embodiment is not used. A battery (not shown) of a widely used type is contained in the camera body 3. A shape memory alloy wire 70a as resilient element is mounted in the bezel 70, and keeps the display unit 4 flat. The flexible protection film 71 is opaque and blocks light. In the flexible protection film 71 is formed a light transmitting pattern 71a by cutting locally. The light transmitting pattern 71a has an alphanumerically patterned shape of FmeRix which is a product name of the camera. When EL elements in the organic ELD panel 19 are driven to illuminate, light is passed through the light transmitting pattern 71a toward the rear, to show the alphanumerically patterned shape with light. In FIG. 19, the display unit 4 without the flexible protection film 71 is depicted.

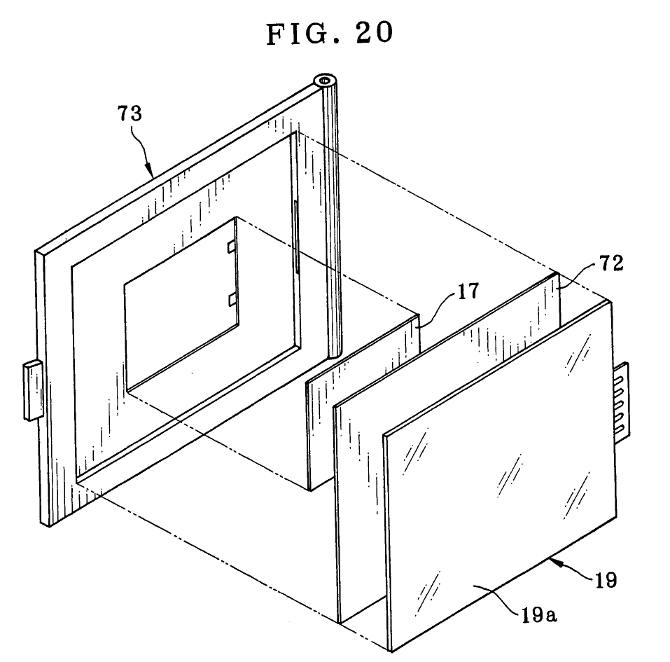

In FIG. 20, an example having a bezel 73 and a stainless flat panel 72 as resilient element is illustrated. The organic ELD panel 19, the stainless flat panel 72 and the sheet battery 17 are overlaid on one another, and supported by the bezel 73. The stainless flat panel 72 behind the organic ELD panel 19 has a sheet form. The stainless flat panel 72 has such a characteristic that, when curved by applying external force, the stainless flat panel 72 tends to recover its original flat shape. For a panel, various examples other than stainless steel can be used, such as Ni—Ti alloy, polymer and other hyperelastic materials. The bezel 73 is formed from elastomer and is flexible.

Furthermore, it is possible to use retaining structures other than the retention claw 23 or the fastening clamp 63. For example, caps (not shown) can be used to hold the digital still camera 2 with the display unit 4 rolled thereabout. When the caps are removed from the digital still camera 2, the display unit 4 will be spread flatly by resiliency of the shape memory alloy or stainless plate.

In the above embodiments, the display unit 4 recovers its flat shape in response to discontinuing external force to keep the roll form. Alternatively, an element with plastic deformability may be incorporated in the display unit 4 in place of the wire or stainless plate. Example of this is plastically deformable wire. This makes it possible to keep the display unit 4 fitted on the camera body without force or stress to the display unit 4 or without retaining mechanism of the above. For the purpose of using the display unit 4, a user can spread the display unit 4 manually, and keep the display unit 4 in a flat state owing to the plastic deformability.

Note that it is further possible for the display unit 4 to have two display surfaces directed in directions opposite to one another, in contrast with the display surface 19a being single according to the above embodiment.

In the above embodiment, the organic ELD panel 19 is used. However, a display panel of the invention may be a film liquid crystal panel, inorganic ELD panel, or other flexible structures of a light valve of a visible type. Furthermore, it is preferable to use a backlight in combination with a film liquid crystal panel. An example of the backlight can be an organic ELD panel of a white color for use simply as a light source.

In the above embodiment, the USB port 49 is provided in the camera body 3. However, interfacial connection of he digital still camera 2 with external instruments may be according to a system other than USB, for example according to IEEE 1394 connection. Also, extra interfaces may be added besides the USB port 49, for example, an infrared communication interface. Furthermore, the external instruments connectable with the digital still camera 2 may be PDA, cellular telephone or the like other then a computer.

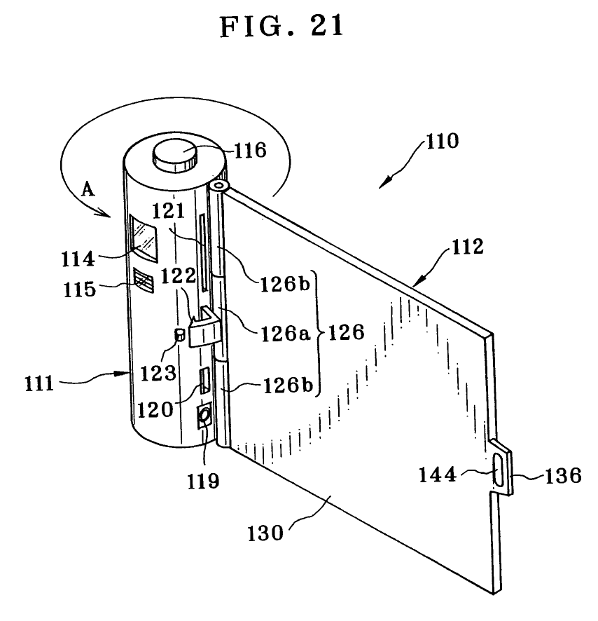

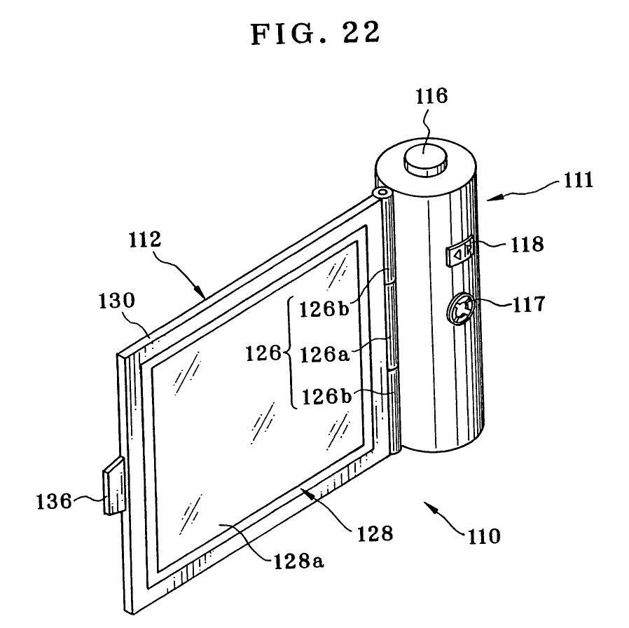

In FIGS. 21 and 22, another preferred digital still camera 110 is illustrated. A camera body 111 has a generally cylindrical form. A display unit 112 is connected with the camera body 111, is flexible, and operates as an electronic viewfinder.

A front face of the camera body 111 has a photographing lens 114, a flash light source 115, and a shutter release button 116. The shutter release button 116 is depressible for releasing the electronic shutter. A rear face of the camera body 111 has as a camera input unit, namely a general-purpose cross-shaped key 117 and an operation button 118, which is used for various purposes such as mode selection, to set one of an image pickup mode and a playback mode for playing back stored images. A lateral face of the camera body 111 has a DC jack 119, a USB (Universal Serial Bus) port 120 of an interface, a memory card slot 121, a retention claw or hook 122, and a power switch 123. The DC jack 119 is connectable with a line to supply power in connection with an electrical outlet (not shown), and also with a plug (not shown) for electrically charging a battery loaded in the camera body 111. The USB port 120 outputs image data to a personal computer or other electronic equipment. The memory card slot 121 is loadable with a memory card (See FIG. 3) where image data is stored. The retention claw 122 keeps the display unit 112 retained in a rolled state, which will be described later in detail. The power switch 123 is a detector of a pushbutton type to turn on and off the power supply of the camera. Also, the power switch 123 is a normal open type.

In the image pickup mode, a user grasps the camera body 111 with a right hand, and takes an exposure in observing an image of the display unit 112. In the course of this, a thumb of his or her right hand can push any of the cross-shaped key 117 and the operation button 118. An index finger of the right hand can push the shutter release button 116. Therefore, the digital still camera 110 can be handled only with the right hand. Upon depression of the shutter release button 116, a CCD image sensor (not shown) behind the photographing lens 114 retrieves an object image focused on the photosensitive plane as an image signal of an analog form. The image signal of a retrieved image is converted into digital image data, which is processed in image processing of various types. Then the image data is written to an image memory (not shown) in the camera body 111.

While the playback mode is set, a pickup image stored in the image memory or memory card (See FIG. 3) is read and displayed on the display unit 112. A user can operate the cross-shaped key 117 or the operation button 118 with his or her thumb while the camera body 111 is grasped with a right hand, so as to change over the displayed image. It is possible to form an additional grip on a lateral face of the camera body 111 so as to facilitate grasping of the user for the camera body 111 when one of the pickup mode or the playback mode is set.

A hinge mechanism 126 connects the display unit 112 with the camera body 111 of the present invention. The hinge mechanism 126 includes a camera hinge shaft 126a and a hinge receiving portion 126b. The camera hinge shaft 126a is formed with the camera body 111. The hinge receiving portion 126b is formed with the display unit 112, and has a rotational axis that extends perpendicular to the photographic optical axis of the camera. The display unit 112 is rotated about the hinge mechanism 126 so as to adjust the angle of the display unit 112 relative to the camera body 111 to a high degree of freedom.

A fastening mechanism (not shown) with a click is provided on the hinge mechanism 126, and keeps the display unit 112 retained in an erect position of FIG. 21 from the camera body 111. Note that a frictional structure may be used between the camera hinge shaft 126a and the hinge receiving portion 126b, so that the display unit 112 can be set in an undefined rotationally middle position desired by a user and short of the erect position, which is useful for the user to observe an image easily.

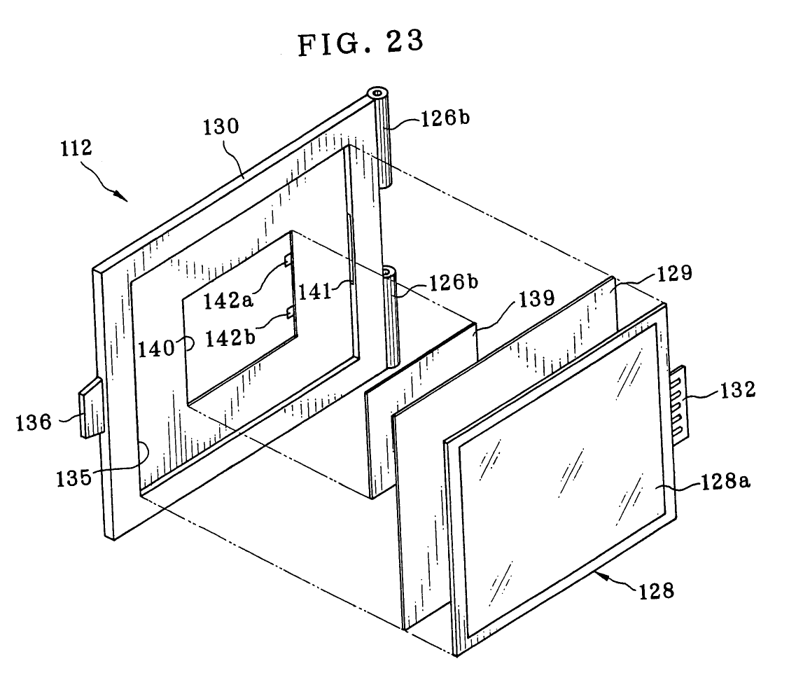

In FIG. 23, the display unit 112 is constituted by an organic ELD (electroluminescence display) panel 128, a stainless flat panel 129, and a bezel 130 as resilient element. The stainless flat panel 129 has a small thickness like a sheet, and protects a rear of the organic ELD panel 128. The bezel 130 supports the organic ELD panel 128 and the stainless flat panel 129. The organic ELD panel 128 has a sheet form and includes organic EL elements (not shown). As well-known in the art, the organic ELD panel 128 has a transparent plastic base plate, and two electrode layers of an anode and cathode. The base plate has flexibility. The two electrode layers of an anode and cathode are overlaid on the base plate. The organic EL elements are mounted between the two layers. When a voltage is applied across the electrode layers, the organic EL elements (not shown) emits light responsively. Each element is used as one pixel. The numerous elements are arranged in a matrix form and for three colors of blue, red and green, and selectively driven to display a full-color image. Even when the organic ELD panel 128 is bent or curved, a display surface 128a of the organic ELD panel 128 can display the full-color image. A male connector 132 is included in a right end of the organic ELD panel 128, and connectable with a control circuit (not shown) in the camera body 111.

The stainless flat panel 129 has such a size and thickness that it can be curved or flexed. As will be described, the stainless flat panel 129 is a plate spring having such resiliency that curving or bending the display unit 112 with the stainless flat panel 129 will spread and flatten the display unit 112. Note that the material for the stainless flat panel 129 may be hyperelastic material other than the stainless steel, for example, Ni—Ti alloy or other metal, and polymer. Also, a plurality of slits, punch holes or other negative portions may be formed in the stainless flat panel 129 for reducing a weight of the digital still camera 110.

The bezel 130 is formed from elastomer or other organic material, and is flexible. A panel chamber 135 is formed in the bezel 130 for containing the organic ELD panel 128 and the stainless flat panel 129 as well as the hinge receiving portion 126b. Also, a retention projection 136 is formed on a second end of the bezel 130 for retention to the retention claw 122, the second end being opposite to a first end provided with the hinge receiving portion 126b. Note that a material for the bezel 130 may be other than elastomer, for example resin, metal or the like having suitably sufficient flexibility.

A battery cavity 140 is formed through the panel chamber 135. A sheet battery or sheet-shaped battery 139 is loaded in the battery cavity 140 and supplies various circuits of the digital still camera 110 with power. A female connector 141 is disposed in the panel chamber 135, and connectable with the male connector 132 of the organic ELD panel 128. The organic ELD panel 128 and the stainless flat panel 129 are set in the panel chamber 135 after insertion of the sheet battery 139, and firmly secured to the inside of the panel chamber 135 with adhesive agent or the like.

In general, a widely available type of battery has a casing of aluminum or stainless steel in a box shape or cylindrical shape, and substance for producing electricity. Unlike such types, the sheet battery 139 has outer sealed layers formed from sheets of macromolecular compounds, which can reduce a back-to-front thickness and can provide flexibility. So the sheet battery 139 is characteristically foldable and flexible. In the battery cavity 140 are disposed a positive electrode segment 142a and a negative electrode segment 142b, which are opposed to an anode and a cathode (not shown) of the sheet battery 139 being contained. Power is supplied by the electrode segments 142a and 142b to elements of the camera. Also, the electrode segments 142a and 142b cause a current to flow to charge the sheet battery 139 electrically. Note that the sheet battery 139 in the battery cavity 140 is entirely covered by the stainless flat panel 129. No lid for closing the chamber of the sheet battery 139 is required in particular.

In the display unit 112, every element which is the organic ELD panel 128, the stainless flat panel 129 and the bezel 130 has a flexible characteristic. Also, the sheet battery 139 in the display unit 112 is flexible. Consequently, the display unit 112 can be bent or flexed. When the display unit 112 is not used, the display unit 112 may be contained in the state suggested in JP-A 2003-309744, and contained in the camera body 111. However, this requires a space in the camera body 111 for containing the display unit 112. The containing space must be large particularly if the display surface 128a of the organic ELD panel 128 has a large size. A lower limit may occur in raising portability of the camera by means of to down sizing of the digital still camera 110.

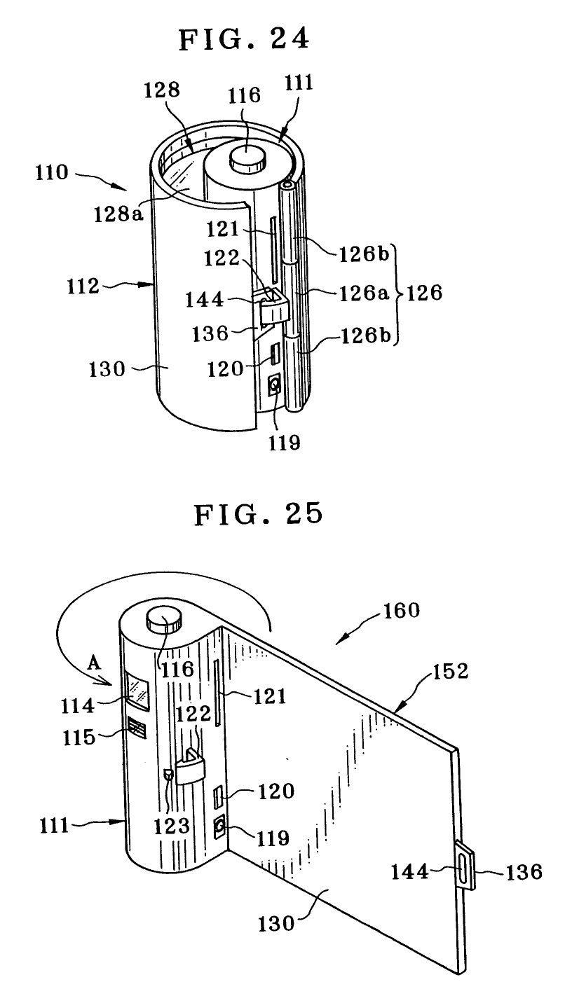

In FIG. 24, the display unit 112 while not used is fitted about the camera body 111 in the direction A in FIG. 21. The retention projection 136 of the display unit 112 is retained on the retention claw 122 while the display surface 128a of the display unit 112 is opposed to the periphery of the camera body 111. This form is effective in high portability of the digital still camera 110 with a considerably reduced size.

In FIGS. 21 and 24, a retention slot 144 is formed in a surface of the retention projection 136 opposite to the display surface 128a for retaining the retention claw 122. When the display panel is not used, the display unit 112 is fitted about the camera body 111 by directing the display surface 128a internally, and retained by engaging the retention claw 122 with the retention slot 144 of the retention projection 136. Thus, the display unit 112 can be kept on the camera body 111 firmly. As the display surface 128a is directed inside in a rolled state on the camera body 111, no further protection is required for the display surface 128a. It is possible to minimize the size of the digital still camera 110 in a state of not using the display panel.

The hinge mechanism 126 and the retention claw 122 are so positioned that, in engaging the display unit 112 with the camera body 111, the photographing lens 114 and the flash light source 115 are covered by the display unit 112. Therefore, the photographing lens 114 and the flash light source 115 can be protected while the display unit 112 is rolled and not used. No lens cover and no flash cover are required. The number of the parts of the digital still camera 110 can reduced, to lower the manufacturing cost of the camera. Furthermore, the DC jack 119 and the memory card slot 121 are positioned suitably for charging the sheet battery 139 and for handling a memory card (not shown) storing image data while the display unit 112 is rolled and not used. See FIG. 24.

For any one of the image pickup and playback, the retention projection 136 is pressed against the camera body 111, to disengage the retention claw 122 from the retention slot 144 of the retention projection 136. Thus, the retention of the display unit 112 can be released. In response to the disengagement, the display unit 112 about the camera body 111 can be spread flatly by the stainless flat panel 129. In FIG. 24, the display unit 112 is in the rolled state. The display surface 128a is directed inside in winding the display unit 112 on the camera body 111. In FIG. 21, the display unit 112 is in the widely spread state. The display surface 128a extends erectly from the display unit 112. It is possible with a manual touch to change the display unit 112 from the rolled state to the widely spread state very promptly.

Power source of the digital still camera 110 is turned on and off in response to changing over the display unit 112 between the rolled and spread states. To this end, the power switch 123 is disposed near to the retention claw 122 as a pushbutton type for a power source. The power switch 123 may be positioned for being pressed by one of the bezel 130 and the retention projection 136 retained on the retention claw 122 when the display unit 112 is not used. The power switch 123 checks whether the display unit 112 is in the rolled state or not. Also, the power supply of the digital still camera 110 is kept turned off while the power switch 123 is pressed. The power supply of the digital still camera 110 is turned on while the power switch 123 is released from pressure. When the display unit 112 is released from the retention in the rolled state, the power supply for the camera is automatically turned on. In contrast, when the display unit 112 is retained in the rolled state, the power supply for the camera is automatically turned off. This is effective in automating turning on and off and saving manual operation of the user.

This being so, the display unit 112 is constituted by such flexible elements as the organic ELD panel 128 and the bezel 130. A first end of the display unit 112 is connected by the hinge mechanism 126 to the camera body 111. When the display panel is not used, the display surface 128a can be directed internally and wound about the camera body 111. A second end of the display panel is retained on the camera body 111. It is unnecessary to contain the display unit 112 into the camera body 111, or protect the display surface 128a externally. As a result, the size of the digital still camera 110 in the rolled state can be reduced no matter how large the display surface 128a is. The portability of the digital still camera 110 can be high.

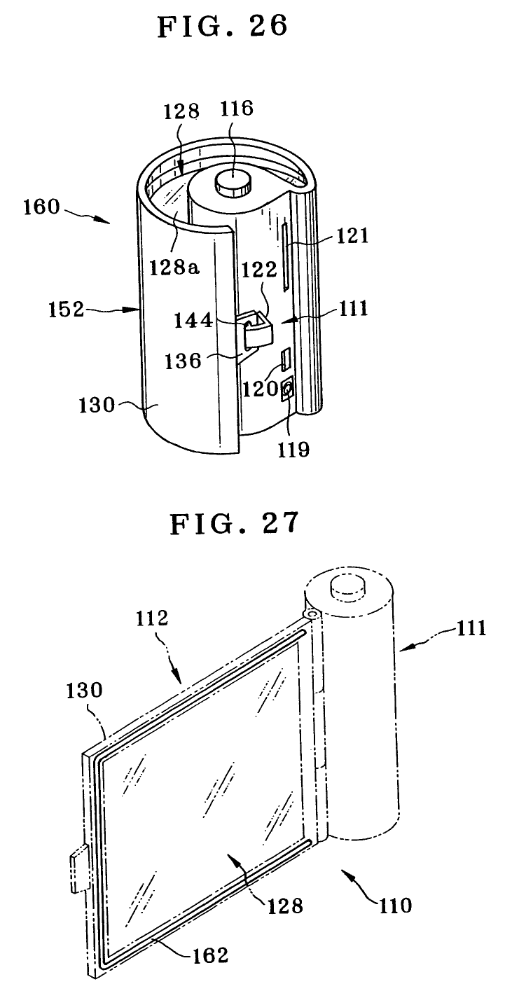

In the above embodiment, the hinge mechanism 126 is used. However, other structures may be used. See FIGS. 25 and 26. A digital still camera 160 of another preferred embodiment has a display unit 152 connected firmly with the camera body 111. In FIGS. 25 and 26, the digital still camera 160 is in respectively the spread and rolled states. The digital still camera 160 is different in the secured or not secured state of the display unit 112, 152 on the camera body 111. Elements similar to those of the above embodiment are designated with identical reference numerals.

In FIGS. 25 and 26, the display unit 152 is firmly secured to the camera body 111 in the digital still camera 160. Various methods can be used for connecting the bezel 130 of the display unit 152 with the camera body 111. For example, adhesive agent is applied to the display unit 152 for attachment to the camera body 111. Screws may be used to fasten the display unit 152 to the camera body 111. Otherwise, the bezel 130 may be included in one piece having the camera body 111. To this end, elastomer resin or other resilient material can be used to form the piece having the camera body 111 and the bezel 130.

The display unit 152 can be bent and flexed even in the structure protruded from the camera body 111, because of the flexibility. When the display unit 152 is not used, the display unit 152 is bent and fitted about the camera body 111 in the direction A of FIG. 25. The display surface 128a of the display unit 152 is opposed directly on the camera body 111. The retention claw 122 is engaged with and retained on the retention slot 144 of the retention projection 136. The display unit 152 can be retained on the camera body 111 with the display surface 128a directed inwards. See FIG. 26.

In the display unit 152, when the display panel is not used, the display surface 128a can be directed internally and wound about the camera body 111, and retained on the camera body 111. It is unnecessary to contain the display unit 152 into the camera body 111, or protect the display surface 128a externally. In a manner similar to the above embodiment, the size of the digital still camera 160 in the rolled state can be reduced no matter how large the display surface 128a is. The portability of the digital still camera 160 can be high.

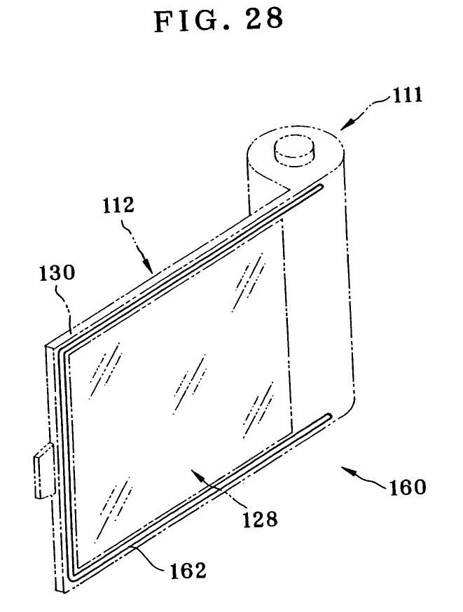

In the above embodiment, the stainless flat panel 129 is used for spreading the display unit 112. However, other structures may be used. In FIGS. 27 and 28, shape memory alloy wire 162 is disposed to in the bezel 130 and about the organic ELD panel 128 in the panel chamber 135, for keeping the display unit 112 flat. In FIG. 27, the digital still camera 110 provided with the shape memory alloy wire 162 is depicted without the stainless flat panel 129. In FIG. 28, the digital still camera 160 provided with the shape memory alloy wire 162 is depicted. In any of those, the shape memory alloy wire 162 in a U shape is used in place of the stainless flat panel 129. It is possible by use of the shape memory alloy wire 162 to spread the display unit 112 in a widely spread state even with an instantaneous manual touch. Preferable examples of materials for the shape memory alloy wire 162 are Ni—Ti alloy, polymer and other hyperelastic materials.

Furthermore, the power switch 123 can be a type other than the button switch. For example, a switch having a Hall element, a photo sensor and the like can be used for the purpose of checking a retained state of the retention projection 136 on the retention claw 122, namely the spread or rolled state of the display unit 112. Also, the power switch 123 may be disposed on a portion of the digital still camera 110 not near to the retention claw 122, so as to checking the roll form of the display unit 112 about the camera body 111.

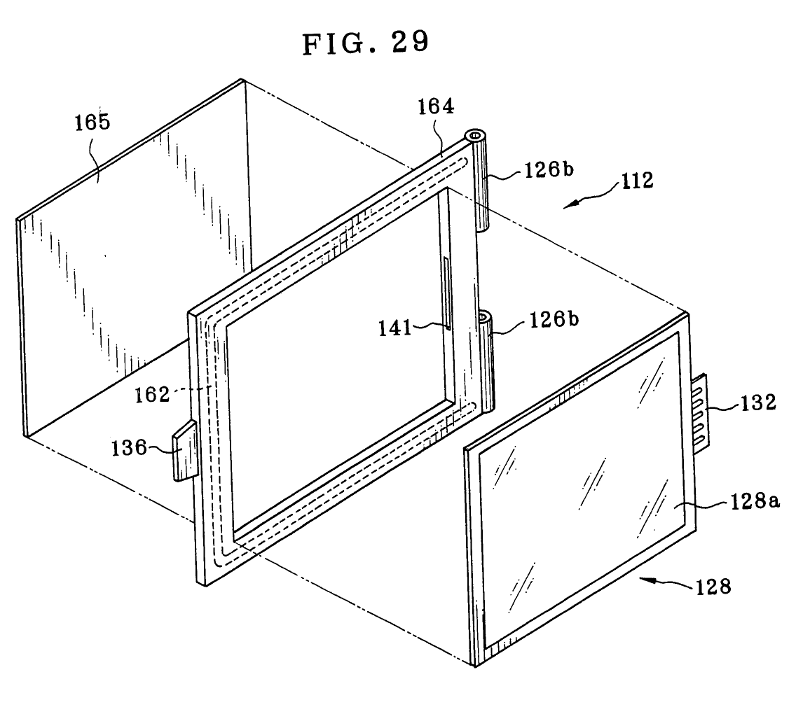

In addition to the above, various types of batteries different from the sheet battery 139 may be used, and may not have flexibility if the camera body 111 has a space sufficient for containing a battery. Such batteries can be button cells, columnar types, box-shaped types and the like. In FIG. 29, an example of the display unit 112 includes the organic ELD panel 128, a bezel 164 as resilient element and a flexible protection film 165. The bezel 164 has a shape to extend along the periphery of the organic ELD panel 128. The flexible protection film 165 protects the rear of the organic ELD panel 128. Any flexible material may be used for forming the flexible protection film 165, for example, elastomer. The shape memory alloy wire 162 can be preferably contained in the bezel 164. Also, the bezel 164 may not have the shape memory alloy wire 162. In combination with the structure without the shape memory alloy wire 162, the flexible protection film 165 can be formed from stainless steel, Ni—Ti alloy, polymer and other hyperelastic materials.

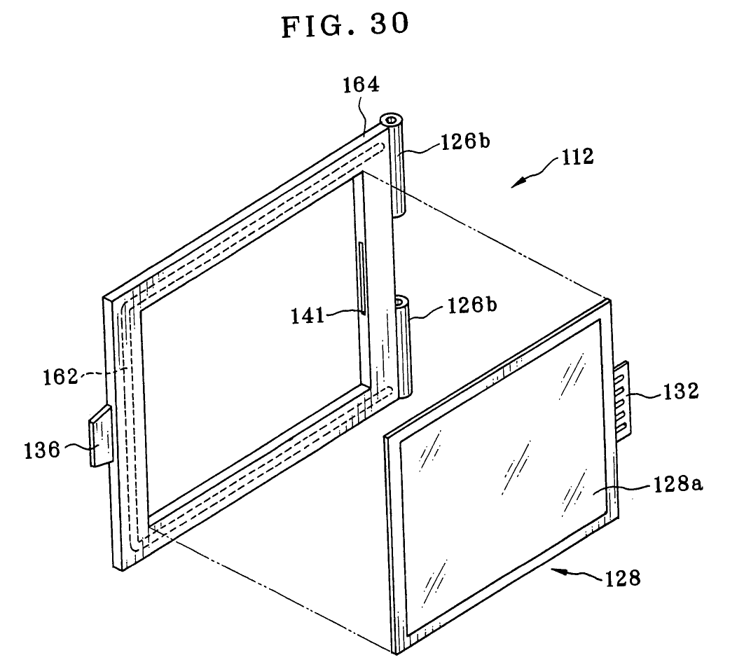

In FIG. 30, another example of the display unit 112 is illustrated, and includes the organic ELD panel 128 and the bezel 164 in a frame shape fittable on the organic ELD panel 128. The shape memory alloy wire 162 is contained in the bezel 164. This is in contrast with the structure in FIG. 29 with the flexible protection film 165.

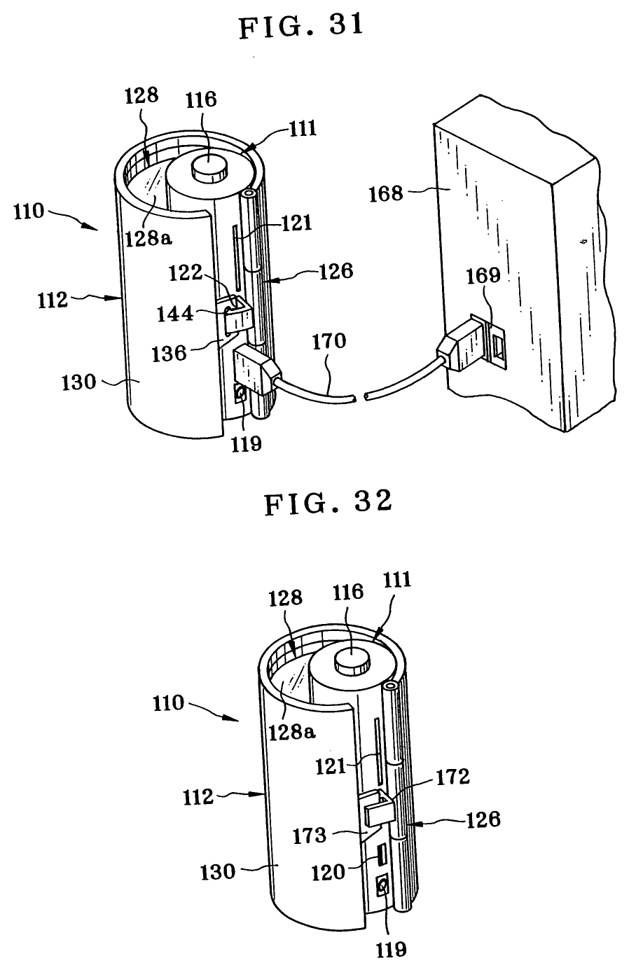

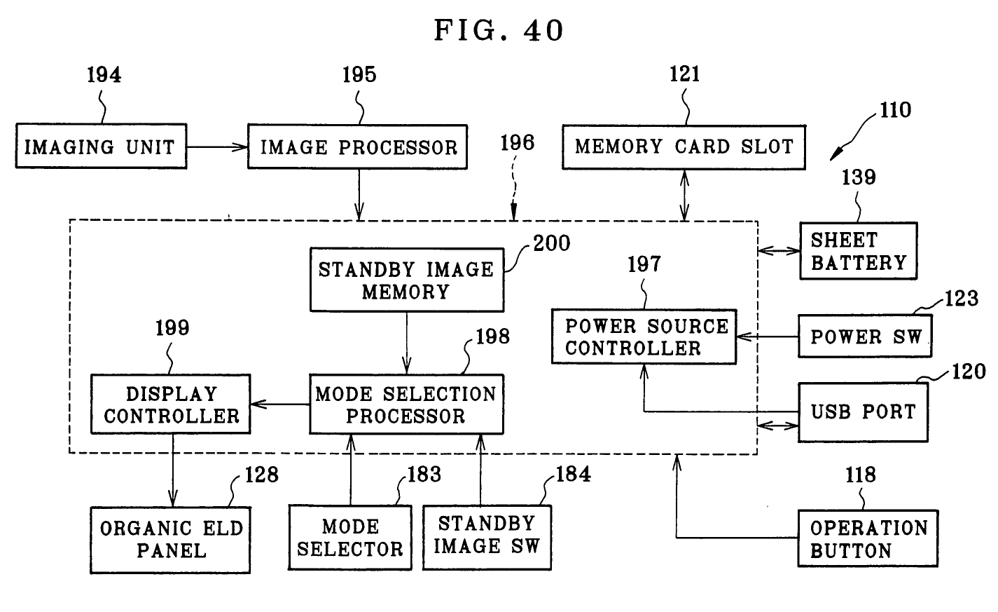

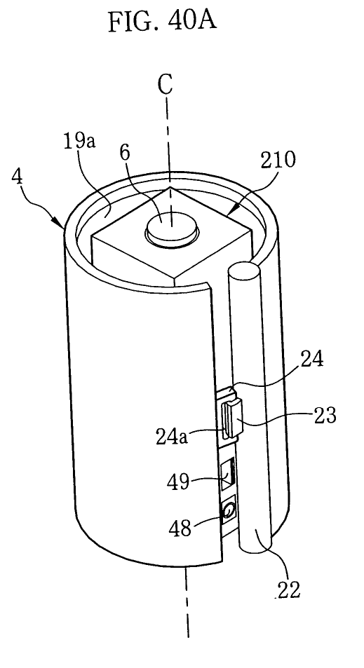

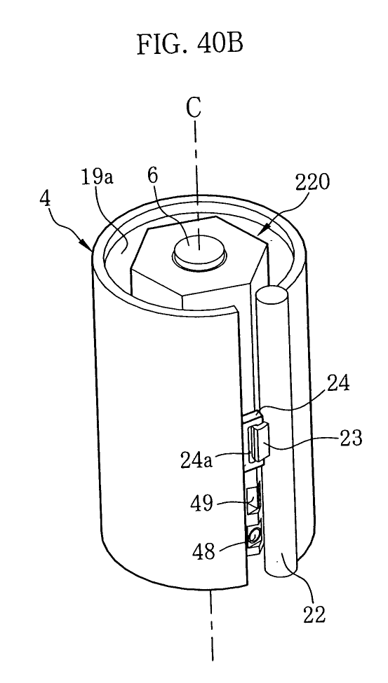

In the above embodiment, the power switch 123 is used for automatically turning on. However, other switches may be used. In the digital still camera 110, the USB port 120 is positioned not to be covered by the display unit 112 even in the rolled state. See FIG. 24. In FIG. 31, a USB (Universal Serial Bus) port 169 of a personal computer 168 is connected with the USB port 120 by a USB (Universal Serial Bus) connection cable 170. In response to this connection, the power source for the digital still camera 110 is automatically turned on, to transmit image data of images picked up in the camera to the computer 168. See FIG. 40. It is preferable that, at the same time as turning on the power supply, a camera mode of the digital still camera 110 can be automatically changed over to a computer connecting mode for communication with the computer 168. It is unnecessary manually to turn on the power source of the digital still camera 110 upon retrieving image data.

Note that various interfaces can be used in the connection of the digital still camera 110 to the computer 168, for example, interfaces of IEEE 1394 connection, infrared communication, wireless communication and other communicating systems. The digital still camera 110 is preferably constructed to turn on the power supply in response to connection with the computer 168 through a line or wirelessly. Also, the digital still camera 110 is automatically changed over to a computer connecting mode where the digital still camera 110 is set in communication with the computer 168. Furthermore, the external instruments connectable with the digital still camera 110 may be PDA, cellular telephone or the like other then the computer 168.

Furthermore, the display unit 112 in the rolled state may be retained by structures other the retention claw 122 and the retention projection 136. The display unit 112 should be retained in a rolled state by suitable structures. For example, a male button portion and a female button portion can be used for retaining the display unit 112 in the rolled state. Also, the position of the retention projection 136 may be modified. For example, the retention projection 136 may be positioned at an upper end or lower end in a manner different from that of FIGS. 21-23. Of course, the retention claw 122 can be formed in correspondence with the retention projection 136. Furthermore, a cap (not shown) for retention can be used for retaining an end of the digital still camera 110 in the rolled state of the display unit 112. If the digital still camera 110 is unloaded from the cap, the display unit 112 responsively spreads flatly.

The display unit 112 can be retained in a manner of FIG. 32. A fastening clamp 172 is formed with the camera body 111 for nipping the display unit 112, which is in place of the retention claw 122 of FIGS. 21 and 24. A fastening end projection 173 is formed with one end of the bezel 130 of the display unit 112 for being nipped by the fastening clamp 172, which is in place of the retention projection 136 of FIGS. 21 and 24. In the display unit 112, when the display panel is not used, the display surface 128a can be directed internally and wound about the camera body 111, and retained on the camera body 111, because the fastening end projection 173 can remain nipped by the fastening clamp 172. Also, it is possible to nip one end of the display unit 112 directly on the fastening clamp 172 without forming the fastening end projection 173 on the end. Various shapes of the fastening clamp 172 can be used in a form capable of nipping the fastening end projection 173 or the end of the display unit 112.

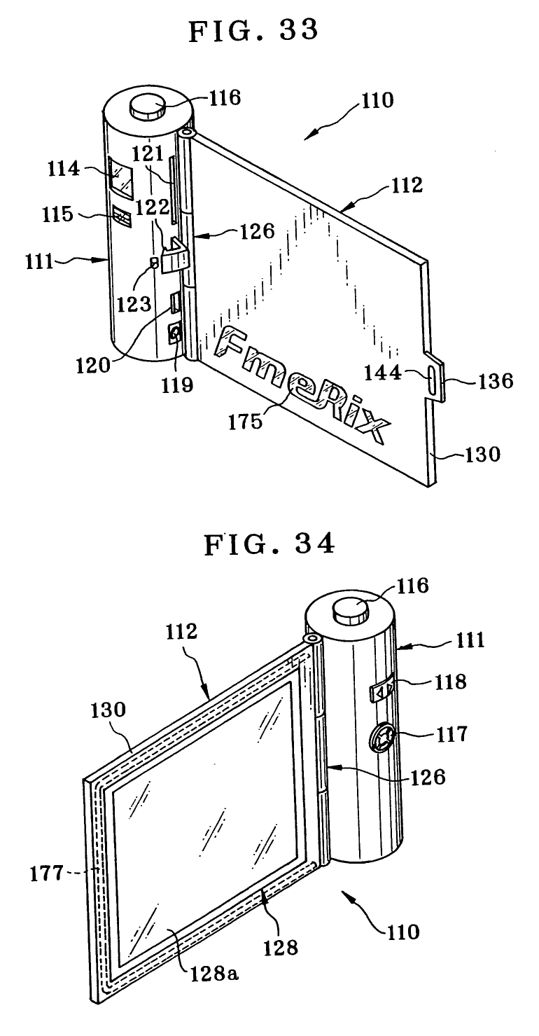

It is also possible to provide a logo indicia 175 expressed alphanumerically or information of a camera model or manufacture in the digital still camera 110, 160. See FIG. 33. The bezel 130 behind the display unit 112 is formed from material in which a portion for displaying the logo indicia 175 has high transmittance and flexibility. The logo indicia 175 can be illuminated by leaked light of the organic ELD panel 128 illuminating in the course of using the display unit 112. Also, an opening or the like through the stainless flat panel 129 for introducing light from the organic ELD panel 128 toward the logo indicia 175 as the stainless flat panel 129 and the sheet battery 139 are disposed between the organic ELD panel 128 and the bezel 130 as illustrated in FIG. 23. A position of the battery cavity 140 is offset for this purpose. In FIG. 29, the rear of the display unit 112 is constituted by the flexible protection film 165. The flexible protection film 165 is formed from material in which a portion for displaying the logo indicia 175 has high transmittance and flexibility, and a remaining portion offset from the logo indicia 175 has opacity and flexibility. Instead of the logo indicia 175, a pattern in a decorative, abstract or symbolical form may be provided in the transmittance portion.

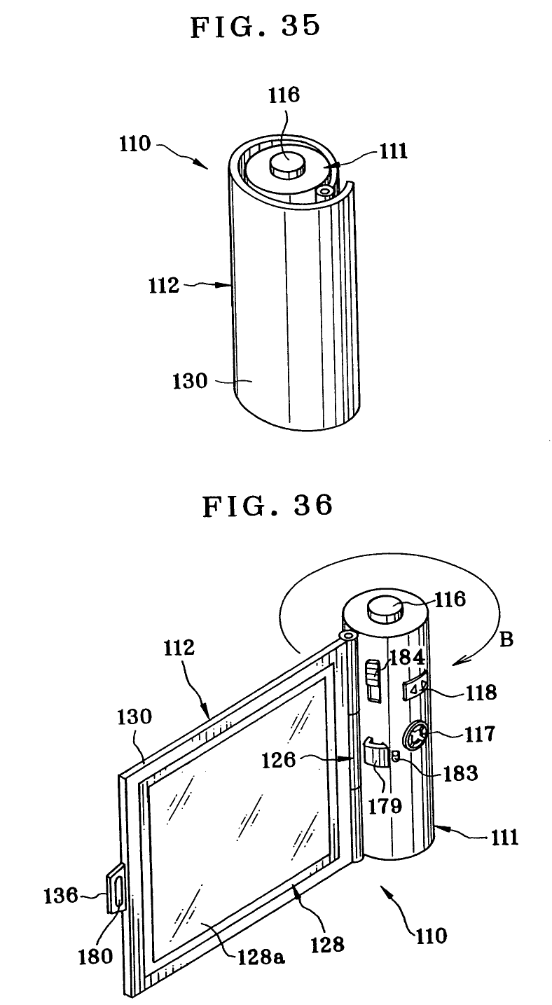

In FIG. 34, an example of the display unit 112 with a metal wire 177 with plastic deformability is illustrated. In place of the stainless flat panel 129 of FIG. 23 or the shape memory alloy wire 162 of FIGS. 27 and 28, the metal wire 177 is plastically deformable. See FIG. 35. The metal wire 177 can keep the display unit 112 wound about the camera body 111 without the retention claw 122 and the retention projection 136. To use the display unit 112, a user can spread and flatten the display unit 112 by his or her manual handling about the camera body 111. Note that the display unit 112 may have a greater length, or may have a length equal to that of one circumference of the camera body 111. This causes the display unit 112 to cover the whole circumference of the camera body 111. The DC jack 119, the USB port 120 and the memory card slot 121 should be disposed on an upper face or a lower face of the camera body 111 (which structure is not shown).

Furthermore, a plastically deformable panel of metal (not shown) may be disposed behind the organic ELD panel 128 in place of the stainless flat panel 129 of FIG. 23. The panel is effective in keeping the display unit 112 fitted on the camera body 111 with the display surface 128a directed inwards, as depicted in FIG. 35.

In FIGS. 36-38, another example is illustrated, in which the display unit 112 is settable so that the display surface 128a is directed externally while the display unit 112 is fitted about the camera body 111. The arrow B indicates a direction of setting the display unit 112 to the camera body 111. A retention claw or hook 179 is formed with the camera body 111, for retaining the display unit 112 when the display surface 128a is directed outside about the camera body 111. A retention slot 180 is formed in one portion of the retention projection 136 close to the display surface 128a, and retains the retention claw 179.

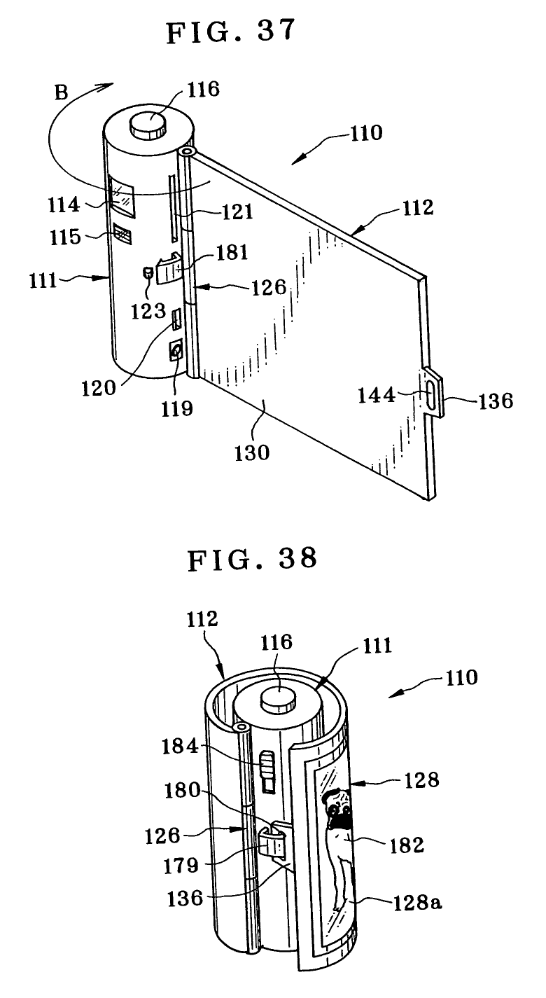

Although the display unit 112 can be fitted in any of the two directions to direct the display surface 128a inwards and outwards, it is likely that the retention claw 179 causes unwanted problems in rolling of the display unit 112 on the camera body 111. For example, the retention claw 179 may be obstruct the rolling, or may scratch the display surface 128a. A form of the retention claw 179 is preferably considerably small so as to be short of scratching the display surface 128a, and not to hinder operation of rolling of the display unit 112. A retention claw or hook 181 of FIG. 37 is preferably formed instead of the retention claw 122 and shaped equally to the retention claw 179. Also, rubber or other elastic material may be used to form the retention claw 179 and 181, which can be deformed when pressed by the display unit 112. Also, the retention claw 179 and the retention claw 181 may be contained in the camera body 111.

Also, a standby image 182 may be displayed on the display surface 128a typically when the display surface 128a of the display unit 112 is kept directed externally about the camera body 111. A mode selecting switch 183 for a mode selection as a detector a pushbutton type is disposed near to the retention claw 179 for being pressed by the retention projection 136 retained on the retention claw 179. The mode selecting switch 183 checks whether the display unit 112 is fitted about the camera body 111 and with the display surface 128a directed externally. As will be described later in detail, the camera mode of the digital still camera 110 is changed over to the standby mode in which the standby image 182 can be displayable on the display surface 128a. See FIG. 40. This can cause the digital still camera 110 in the rolled state to have a good appearance. Note that various manners of displacing information can be used for the standby image 182, for example photographed image, a motion picture, time, calendar or the like. Furthermore, the digital still camera 110 is changed over to a first mode from the standby mode in response to releasing pressure to the mode selecting switch 183. The first mode may by one of an image pickup mode and a playback mode any of which has been set by means of the operation button 118.

In FIGS. 36 and 38, a standby image switch 184 as a detector is disposed outside the camera body 111 and offset from the display unit 112 fitted on the camera body 111, to change over effective and ineffective states of the standby image 182 while the standby mode is set. When the suppression of displaying the standby image 182 is set by operating the standby image switch 184, displaying of the standby image 182 is suppressed, to minimize wasteful use of power of the camera in the standby mode.

Preferably, the mode selecting switch 183 is used as a power switch. When the display unit 112 is fitted about the camera body 111 by directing the display surface 128a externally, a power supply of the digital still camera 110 is turned off automatically. When the display unit 112 is unwound from the camera body 111, the mode selecting switch 183 can turn on the power supply. Alternatively, the power switch 123 can be used as a mode selection switch. When the display unit 112 is fitted about the camera body 111 by directing the display surface 128a internally, a first one of two modes can be set in the digital still camera 110. When the display unit 112 is unwound from the camera body 111, a second one of the two modes can be set.

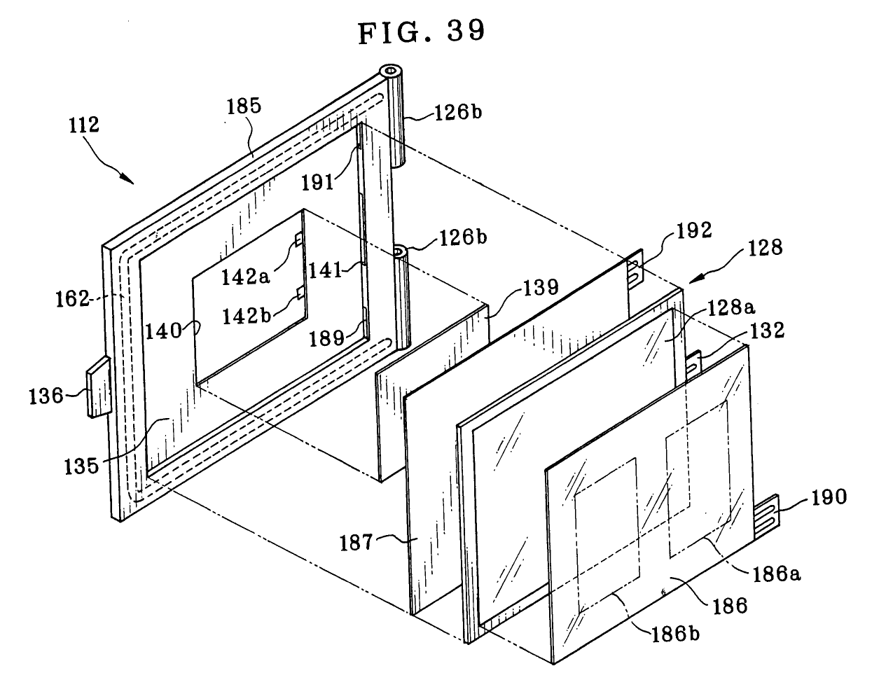

Note that the digital still camera 110 is changeable to the playback mode. It is additionally possible to play back motion picture in the playback mode. To this end, motion picture data is read from a memory card (See FIG. 3) after image pickup in a separate digital video camera. It is preferable to play back recorded sounds at the same time as the motion picture is played back. In FIG. 39, the display unit 112 is constituted by a bezel 185 as resilient element, a sheet speaker or sound source 186, and a flexible wiring board 187 together with the organic ELD panel 128 and the sheet battery 139. The bezel 185 has the shape memory alloy wire 162 incorporated therein.

The sheet speaker 186 is used as attached on the display surface 128a of the organic ELD panel 128. Any suitable type of the sheet speaker 186 can be used with features of transparency and flexibility. The sheet speaker 186 includes two-channel speaker units or sound source units 186a and 186b and a male connector 190. The speaker units 186a and 186b generate sound for playback in a stereo manner. A female connector 189 is disposed in the panel chamber 135. The male connector 190 is connected with the female connector 189.

A male connector 192 is disposed on the flexible wiring board 187. A female connector 191 of the panel chamber 135 is connectable with the male connector 192. The organic ELD panel 128 and the sheet speaker 186 are connected electrically with a control circuit board (not shown) in the camera body 111 by the flexible wiring board 187, lines of wire, and the connectors 132, 141, 189, 190, 25 191 and 192. Note that the organic ELD panel 128 and the sheet speaker 186 may be connected directly with the control circuit board (not shown) without transmission through the flexible wiring board 187.

As the sheet speaker 186 is attached on the display surface 128a as depicted in FIG. 39, spaces required with the camera body 111 or the display unit 112 can be economized. Note that the sheet speaker 186 may be attached on a rear surface of the organic ELD panel 128 instead of the display surface 128a. The sheet speaker 186 if attached on the rear surface may be opaque without a transparent characteristic.

The constructions of FIGS. 29-39 is not limited to the digital still camera 110 having the hinge mechanism 126 between the display unit 112 and the camera body 111, but can be used to the digital still camera 160 in which the display unit 112 protrudes from the camera body 111 and remains inseparable.

Furthermore, the camera body according to the invention can have a form of a quadrangular prism 210 of FIG. 40A, hexagonal prism 220 of FIG. 40B, and other polygonal prisms in place of the cylindrical shape of the above embodiments.

Also, the camera body 111 can have a form obtained by parallel movement of a suitable shape of an end face, for example an ellipse in place of the circle according to the above embodiments. Such a suitable shape can be a combination of two semicircles and a quadrilateral, and other combinations of at least one arc and a polygon having one or more straight lines.

Instead of the organic ELD panel 128, a display panel of the invention may be a film liquid crystal panel, inorganic ELD panel, or other structures of a light valve of a visible type. Furthermore, it is preferable to use a backlight in combination with a film liquid crystal panel. An example of the backlight can be an organic ELD panel as a light source disclosed in JP-A 2003-078784.

Note that a camera according to the invention may be an imaging device unlike the digital still camera 110 of the above embodiment, for example a digital video camera having a flexible display panel. Also, an imaging device may be a personal computer of a camera built-in type.

In FIG. 40, circuit elements in any of the digital still camera 110 and 160 are illustrated. This enables control of turning on the power source of the digital still camera 110 upon connection of the USB described by referring to FIG. 31, and control of setting a condition of the display surface 128a for the standby image 182 in the standby mode described by referring to FIGS. 36-38. In FIG. 40, the digital still camera 110 includes an imaging unit 194 having an image pickup device, an image processor 195, and a system controller 196. The imaging unit 194 has the photographing lens 114, a CCD image sensor, A/D converter and other elements. The image processor 195 processes image data obtained by the imaging unit 194. The system controller 196 controls the entirety of the digital still camera 110. Also, the above-described numerous elements are incorporated in the digital still camera 110, for example the operation button 118, the USB port 120, the memory card slot 121, the power switch 123, the organic ELD panel 128, the sheet battery 139, the mode selecting switch 183 and the standby image switch 184.

Various elements are connected with the system controller 196, including the operation button 118, the USB port 120, the memory card slot 121, the power switch 123, the organic ELD panel 128, the sheet battery 139, the mode selecting switch 183, the standby image switch 184 and the image processor 195. The system controller 196 includes a power source controller 197, a mode selection processor 198 of a mode selector, a display controller 199 or display driver, and a standby image memory 200. The power source controller 197 controls turning on and off of the power supply of the digital still camera 110. The mode selection processor 198 changes over the camera mode of the digital still camera 110. The display controller 199 controls the display operation of the organic ELD panel 128. The standby image memory 200 stores image data of the standby image 182. Also, control units (not shown) are included in the system controller 196 for controlling various elements of the digital still camera 110.

The power source controller 197 is responsive to pressing of the power switch 123 when the retention projection 136 is retained on the retention claw 122 for the rolled state of the display unit 112, and turns off the power source of the camera by discontinuing supply of power of the sheet battery 139 to various elements. In contrast, the power source controller 197 is responsive to discontinuing push of the power switch 123 when the retention projection 136 is disengaged from the retention claw 122 for the widely spread state of the display unit 112, and turns on the power source of the camera by discontinuing supply of power of the sheet battery 139 to various elements.

Also, the power source controller 197 turns on the power supply of the sheet battery 139 in the camera in response to detecting connection of the computer 168 with the USB port 120. At this time, it is possible to supply power only to elements in the circuitry required for communication with the computer 168 or other electronic device. No power may be supplied to the organic ELD panel 128, the imaging unit 194 or the image processor 195. Furthermore, turning off of the power supply is preferable in response to disconnection of the computer 168 with the USB port 120.

The mode selection processor 198 is responsive to pressing of the mode selecting switch 183 (See FIG. 38) by retaining the retention projection 136 on the retention claw 179, and sets the standby mode by changing over from any of the image pickup mode and playback mode determined by the operation button 118 in the digital still camera 110. After this, image data of the standby image 182 preselected manually by a user is read from the standby image memory 200. The mode selection processor 198 causes the display controller 199 to display the standby image 182 on the display surface 128a. If the ineffective state or turn-off of the standby image 182 is designated by setting of the standby image switch 184, there is no displaying of the standby image 182 on the display surface 128a.

When the retention projection 136 is disengaged and the mode selecting switch 183 is released from its pressure, the mode selection processor 198 changes over the digital still camera 110 from the standby mode to any of the image pickup mode and playback mode. Then the mode selection processor 198 causes the display controller 199 to change over the display state. If the image pickup mode is set, a live image obtained by the image processor 195 and the imaging unit 194 is displayed by the display controller 199. If the playback mode is set, a playback image read from a memory card (See FIG. 3) is displayed by the display controller 199. Note that, if the computer 168 of FIG. 31 is connected with the USB port 120, the mode selection processor 198 changes over the digital still camera 110 to the computer communicating mode.

Consequently, the power supply for the digital still camera 110 can be turned on in the course of USB connection because the power source controller 197 controls the turning on and off of the power supply of the camera. Also, the display surface 128a when directed outwards about the camera body 111 can be changed over to indicate the standby image 182 because the mode selection processor 198 controls the mode selection to keep the display surface 128a changeable to the standby image 182 upon setting of the standby mode. Note that, if the mode selecting switch 183 is used as power source switch and the power switch 123 is used as mode selection switch, those switches can be connected suitably with the power source controller 197 and the mode selection processor 198.

In the above known documents described as prior art, a takeup spindle for the display unit is incorporated in the camera body, and requires a mechanism specialized for winding the display unit. However, such a winding mechanism is unnecessary according to the present invention. The display unit can be changed over by a simple structure.

In the above prior documents, a takeup spindle is incorporated in the camera body. In contrast, the display unit is fitted on and about the camera body. This is effective in protecting various switches, a release button and the like, so as to prevent erroneous manual handling of the camera.

According to the invention, the display unit in the rolled state covers the camera body and extends to a front side of an entrance opening for the photographing lens. Thus, a conventional lens barrier as an extra structure is not required for the purpose of protecting the photographing lens. Also, surfaces of a flash light source and a viewfinder can be protected, to prevent entry of dust and creation of scratches.

The display surface of the display unit can be set outwards when in the rolled state. This makes it possible to modify a design of the entirety of the camera in the rolled state for future modifications of appearance. Also, information can be displayed visually.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A digital camera comprising:
an image pickup device positioned on a lens optical axis;
a camera body, having a substantially tubular shape, for containing said image pickup device, said camera body having a peripheral surface disposed to surround said lens optical axis; and
a display unit having a sheet form, having flexibility, being changeable between a widely spread state and a state being set about said camera body on said peripheral surface, for displaying an image when widely spread.

2. A digital camera as defined in claim 1, wherein said camera body is connected with said display unit in a rotatable manner about an axis that extends substantially perpendicular to said lens optical axis.

3. A digital camera as defined in claim 2, wherein said display unit protects said peripheral surface when set about.

4. A digital camera as defined in claim 3, wherein said display unit includes:
a frame-shaped support having flexibility; and
a sheet-shaped battery and a flexible display panel, overlapped together, and secured to said frame-shaped support.

5. A digital camera as defined in claim 4, wherein said display unit includes a transparent thin-film sound source, attached on said display panel, for generating sound.

6. A digital camera as defined in claim 1, wherein said display unit has a smaller length than a length of a circumference of said camera body;
wherein said camera body further comprises an exposed outer portion, included in a peripheral surface, for exposing even when said display unit is set on and about without being covered.

7. A digital camera as defined in claim 6, wherein said camera body further comprises an interface, positioned on said exposed outer portion, for outputting image data obtained by said image pickup device to an external electronic device.

8. A digital camera as defined in claim 6, wherein said camera body further comprises a power source connector, positioned on said exposed outer portion, for being supplied with power externally.

9. A digital camera as defined in claim 6, wherein said image pickup device includes a deflecting element for changing a traveling direction of object light being incident, for transmitting along said lens optical axis.

10. A digital camera as defined in claim 9, wherein said deflecting element comprises an achromatic prism including plural optical materials.

11. A digital camera as defined in claim 9, wherein said camera body further comprises a light entrance opening open to an object side;
wherein said camera body is directed to said object side with a downward inclination, and said deflecting element bends a light path of said object light with an upward inclination, and upon entering said light entrance opening, travels said object light on said lens optical axis.

12. A digital camera as defined in claim 9, wherein said camera body further comprises a light entrance opening open to an object side;
wherein said camera body is directed to said object side with an upward inclination, and said deflecting element bends a light path of said object light with a downward inclination, and upon entering said light entrance opening, travels said object light on said lens optical axis.

13. A digital camera as defined in claim 9, wherein said deflecting element comprises a single prism.

14. A digital camera as defined in claim 9, wherein said deflecting element comprises at least one mirror element.

15. A digital camera as defined in claim 9, wherein said deflecting element comprises an apex angle variable prism containing liquid, and having an apex angle controllable for correcting camera shakes.

16. A digital camera as defined in claim 6, wherein further comprising a rotation detector for detecting a rotational position of said camera body with reference to said display unit.

17. A digital camera as defined in claim 16, further comprising a power switch for turning on or off a camera power source according to said rotational position detected by said rotation detector.

18. A digital camera as defined in claim 17, further comprising:
a rotational shaft formed to project from one of a connecting end of said camera body and a connecting panel end of said display unit;
a ring portion, formed on a remaining one of said connecting end of said camera body and said connecting panel end of said display unit, for being engaged with said rotational shaft in a rotatable manner.

19. A digital camera as defined in claim 18, further comprising a mode selector for setting a selected one of plural camera modes according to a rotational position detected by said rotation detector.

20. A digital camera as defined in claim 19, wherein said plural camera modes include an image pickup mode and a playback mode, said image pickup mode being adapted to photographing in said image pickup device, and said playback mode being adapted to playing back an image being picked up.

21. A digital camera as defined in claim 19, wherein said rotation detector includes:
a pair of switch segments for turning on by contacting one another when a first one thereof is pushed;
a cam mechanism, formed on one of said rotational shaft and said ring portion, for shifting between an off position and an on position when said rotational shaft or said ring portion rotates, for coming away from said switch segments when in said off position, and for pushing said first switch segment when in said on position, to cause said switch segments to contact one another.

22. A digital camera as defined in claim 21, further comprising:
an opening formed in said rotational shaft;
a signal line, inserted through said opening and said ring portion, for signal transmission between said display unit and said camera body.

23. A digital camera as defined in claim 19, wherein said display unit is settable in first and second rotational positions relative to said camera body, and an edge of a connecting panel end of said display unit, when in said first rotational position, extends crosswise to a longitudinal direction of said camera body, and when in said second rotational position, extends in said longitudinal direction of said camera body.

24. A digital camera as defined in claim 23, wherein said plural camera modes include an image pickup mode and a playback mode, said image pickup mode being adapted to photographing in said image pickup device, and said playback mode being adapted to playing back an image being picked up;
said rotation detector checks in which of said first and second rotational positions said display unit is set;
said mode selector is responsive to an output of said rotation detector, sets said image pickup mode in response to setting in said first rotational position, and sets said playback mode in response to setting in said second rotational position.

25. A digital camera as defined in claim 24, further comprising an input unit, disposed on said camera body, and directed in a direction in which a display surface of said display unit is directed when in said second rotational position.

26. A digital camera as defined in claim 19, further comprising an input unit, disposed on said camera body, and directed in a direction in which a display surface of said display unit is directed in said playback mode.

27. A digital camera as defined in claim 26, wherein said camera body is positioned to a right of said display unit as viewed from a user side to an object side.

28. A digital camera as defined in claim 27, wherein said input unit is covered with said display unit set on and about said camera body.

29. A digital camera as defined in claim 1, wherein said camera body has a substantially cylindrical shape or a shape of a polygonal prism.

30. A digital camera as defined in claim 1, further comprising a retaining mechanism for retaining said display unit on said camera body with a display surface of said display unit directed inwards in setting on and about said camera body.

31. A digital camera as defined in claim 1, wherein a display surface of said display unit is directed outwards or inwards when set on and about said camera body.

32. A digital camera as defined in claim 31, further comprising a retaining mechanism for retaining said display unit on said camera body with said display surface directed outwards.

33. A digital camera as defined in claim 31, further comprising a retaining mechanism for retaining said display unit on said camera body with said display surface directed inwards, and for retaining said display unit on said camera body with said display surface directed outwards.

34. A digital camera as defined in claim 31, further comprising:
a retaining mechanism for retaining said display unit on said camera body with said display surface directed inwards; and
an auxiliary retaining mechanism for retaining said display unit on said camera body with said display surface directed outwards.

35. A digital camera as defined in claim 1, further comprising a standby image switch for causing said display unit to display a standby image on a display surface thereof while said display unit is set on and about said camera body with said display surface directed outwards.

36. A digital camera as defined in claim 1, further comprising a power source switch for turning off a camera power source when said display unit is set on and about said camera body, and for turning on said camera power source when said display unit is spread from said camera body, to supply power.

37. A digital camera as defined in claim 36, further comprising a retaining mechanism, formed on said camera body, for squeezing an edge of said display unit.

38. A digital camera as defined in claim 37, wherein said display unit includes:
a frame-shaped support having flexibility;
a flexible display panel secured to said frame-shaped support; and
protection film for protecting a rear of said display panel and said frame-shaped support.

39. A digital camera as defined in claim 38, wherein said protection film includes a light transmitting pattern of information.

40. A digital camera as defined in claim 1, further comprising a resilient element, having an extending characteristic, for developing said display unit flatly upon disengagement of a free end of said display unit from said camera body.

41. A digital camera as defined in claim 40, wherein said display unit includes a display panel for displaying an image;
said resilient element is incorporated in said display panel.

42. A digital camera as defined in claim 41, wherein said resilient element has a wire shape or flat plate shape.

43. A digital camera as defined in claim 1, further comprising a plastically deformable element, having a plastically deformable characteristic, being overlapped on said display unit, for keeping said display unit rolled upon setting on and about said camera body, and for setting said display unit flat upon spreading from said camera body.

44. A digital camera comprising:
an image pickup device positioned on a lens optical axis;
a camera body, having a substantially tubular shape, for containing said image pickup device, said camera body having a peripheral surface disposed to surround said lens optical axis; and
a display unit having a sheet form, having flexibility, being changeable between a widely spread state and a protecting state to protect said peripheral surface on said camera body, for displaying an image when widely spread.

45. A digital camera as defined in claim 44, wherein said display unit is bent on and about said peripheral surface when in said protecting state.

46. A digital camera as defined in claim 45, wherein said display unit includes a first end connected with said camera body.

47. A digital camera as defined in claim 46, further comprising:
a light entrance opening formed in said camera body and open to an object side;
a photographing optical system, including at least one objective optical element positioned inside said light entrance opening;
wherein said display unit is opposed to a front side of said light entrance opening when in said protecting state.

48. A digital camera as defined in claim 47, further comprising an input unit, positioned on said camera body, for being covered by said display unit in said protecting state.

49. A digital camera as defined in claim 48, wherein said display unit is connected with said camera body in a rotatable manner about an axis that extends substantially perpendicular to said lens optical axis.

50. A digital camera having a photographing lens, comprising:
a camera body in which said photographing lens is incorporated;
an image pickup device, incorporated behind said photographing lens in said camera body, for photographing an object image; and
a display unit having a sheet form, having flexibility, having a first end connected with said camera body, being changeable between a widely spread state and a state being set on and about a periphery of said camera body, for displaying an image when widely spread according to an image pickup signal from said image pickup device.

51. A digital camera as defined in claim 50, further comprising a resilient element, having an extending characteristic, for developing said display unit flatly upon disengagement of a second end from said camera body, said second end being opposite to said first end.

52. A digital camera as defined in claim 50, further comprising a plastically deformable element, having a plastically deformable characteristic, for keeping said display unit rolled in said state set about, and for setting said display unit flat in said widely spread state.

53. A digital camera as defined in claim 52, wherein said plastically deformable element is metal, and extends along one lateral edge of said display unit.

54. A digital camera as defined in claim 50, wherein said display unit has a smaller length than a length of a circumference of said camera body;
further comprising an exposed outer portion, included in a peripheral surface of said camera body, for exposing even when said display unit is set on and about said camera body without being covered.

55. A digital camera as defined in claim 54, wherein said camera body further comprises an interface, positioned on said exposed outer portion, for outputting image data obtained by said image pickup device to an external electronic device.

56. A digital camera as defined in claim 55, further comprising a power source controller, responsive to connection with said electronic device by said interface, for turning on said camera power source.

57. A digital camera as defined in claim 54, wherein said camera body is in a substantially tubular shape with a peripheral surface provided with at least one of said photographing lens, a flash light source and a camera input unit, and said display unit protects said peripheral surface when set about.

58. A digital camera as defined in claim 54, further comprising a hinge mechanism for securing said camera body in a rotatable manner to said display unit at said first end.

59. A digital camera as defined in claim 54, wherein a display surface of said display unit is directed outwards or inwards when set on and about said camera body.

60. A digital camera as defined in claim 59, further comprising:
a detector for detecting whether said display unit is set on and about said camera body; and
a power source controller for turning off a camera power source when said detector detects setting of said display unit about said camera body, and for turning on said camera power source when said detector detects lack of setting of said display unit about said camera body.

61. A digital camera as defined in claim 59, further comprising:
a detector for detecting whether said display unit is set on and about said camera body; and
a mode selector for changing over a camera mode to a standby mode when said detector detects setting of said display unit about said camera body, and for changing over said camera mode to an image pickup mode or playback mode when said detector detects lack of setting of said display unit about said camera body, wherein said standby mode is adapted to displaying a standby image on said display surface, said image pickup mode is adapted to photographing in said image pickup device, and said playback mode is adapted to playing back an image being stored.

62. A digital camera as defined in claim 50, further comprising:
a first detector for outputting a first signal when said display unit is set on and about said camera body by directing a display surface thereof inwards;
a second detector for outputting a second signal when said display unit is set on and about said camera body by directing said display surface outwards;
a power source controller for turning off a camera power source responsively when said first signal is output, and for turning on said camera power source in discontinuation of outputting of said first signal;
a mode selector for changing over a camera mode to a standby mode responsively when said second signal is output, and for changing over said camera mode to an image pickup mode or playback mode in discontinuation of outputting of said second signal, wherein said standby mode is adapted to displaying a standby image on said display surface, said image pickup mode is adapted to photographing in said image pickup device, and said playback mode is adapted to playing back an image being stored.
